(19) United States
(12) Patent Application Publication
(10) Pub. No.: US 2025/0350967 A1
(43) Pub. Date: Nov. 13, 2025

(54) UE ASSISTED BEAM MANAGEMENT

(71) Applicant: Samsung Electronics Co., Ltd., Suwon-si (KR)

(72) Inventors: Emad Nader Farag, Flanders, NJ (US); Eko Onggosanusi, Coppell, TX (US); Md. Saifur Rahman, Plano, TX (US); Dalin Zhu, Allen, TX (US)

(21) Appl. No.: 19/196,687

(22) Filed: May 1, 2025

Related U.S. Application Data
(60) Provisional application No. 63/646,473, filed on May 13, 2024.
(60) Provisional application No. 63/648,514, filed on May 16, 2024.

(51) Int. Cl. H04W 24/04; H04L 5/00; H04W 76/19

(52) U.S. Cl. CPC H04W 24/04; H04L 5/0048; H04W 76/19

(57) ABSTRACT

Apparatuses and methods for UE assisted beam management for initial access and beam failure detection and recovery in a wireless communication system. A method of operating a first user equipment (UE) is provided. The method includes detecting a beam failure and transmitting, to a second UE, a first beam failure detection message. The method further includes receiving, from the second UE, a first configuration related to first reference signals (RSs) for beam recovery and determining a first RS from the first RSs to use for beam recovery.

### CROSS-REFERENCE TO RELATED APPLICATIONS AND CLAIM OF PRIORITY

The present application claims priority to U.S. Provisional Patent Application No. 63/646,473, filed on May 13, 2024, and U.S. Provisional Patent Application No. 63/648,514, filed on May 16, 2024. The contents of the above-identified patent documents are incorporated herein by reference.

### TECHNICAL FIELD

The present disclosure relates generally to wireless communication systems and, more specifically, the present disclosure relates to user equipment (UE) assisted beam management in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to UE assisted beam management in a wireless communication system.

In one embodiment, a first user equipment (UE) is provided. The first UE includes a processor configured to detect a beam failure and a transceiver operably coupled to the processor. The transceiver is configured to transmit, to a second UE, a first beam failure detection message and receive, from the second UE, a first configuration related to first reference signals (RSS) for beam recovery. The processor is further configured to determine a first RS from the first RSs to use for beam recovery.

In another embodiment, a base station (BS) is provided. The BS includes a transceiver configured to receive a first message, from a first UE, indicating beam failure detection at a second UE and a processor operably coupled to the transceiver. The processor is configured to determine, based on the first message, a configuration related to first RSs for beam recovery at the second UE. The transceiver is further configured to transmit, to the first UE, a second message that includes the configuration related to first RS.

In yet another embodiment, a method of operating a first UE is provided. The method includes detecting a beam failure and transmitting, to a second UE, a first beam failure detection message. The method further includes receiving, from the second UE, a first configuration related to first RSs for beam recovery and determining a first RS from the first RSs to use for beam recovery.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be provided. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to the present disclosure;

FIG. 6 illustrates an example of antenna structure according to embodiments of the present disclosure;

FIG. 7 illustrates an example of beam in a wireless communication system according to embodiments of the present disclosure;

FIG. 8 illustrates an example of multi-beams in a wireless communication system according to embodiments of the present disclosure;

FIG. 9 illustrates an example of a Synchronization Signal/Physical Broadcast Channel (SS/PBCH) Block according to embodiments of the present disclosure;

FIG. 10 illustrates an example of Type-1 random access procedure according to embodiments of the present disclosure;

FIG. 11 illustrates an example of Type-2 random access procedure according to embodiments of the present disclosure;

FIG. 12 illustrates an example of group communication according to embodiments of the present disclosure;

FIG. 13 illustrates an example of group communication including a vehicle according to embodiments of the present disclosure;

FIG. 14 illustrates an example of periodic and aperiodic occasions of beam management reference signal according to embodiments of the present disclosure;

FIG. 15 illustrates an example of link establishment according to embodiments of the present disclosure;

FIG. 16 illustrates a signaling flow of link establishment according to embodiments of the present disclosure;

FIG. 17 illustrates an example of beam management reference signal S configuration according to embodiments of the present disclosure;

FIG. 18 illustrates a signaling flow of link establishment according to embodiments of the present disclosure;

FIG. 19A illustrates another example of link establishment according to embodiments of the present disclosure;

FIG. 19B illustrates a signaling flow of UE assistance of beam failure detection according to embodiments of the present disclosure;

FIG. 20 illustrates another signaling flow of UE assistance of beam failure recovery according to embodiments of the present disclosure;

FIG. 21 illustrates yet another signaling flow of UE assistance of beam failure recovery according to embodiments of the present disclosure;

FIG. 22 illustrates yet another signaling flow of UE assistance of beam failure detection according to embodiments of the present disclosure;

FIG. 23 illustrates yet another signaling flow of UE assistance of beam failure recovery according to embodiments of the present disclosure; and

FIG. 24 illustrates yet another signaling flow of UE assistance of beam failure recovery according to embodiments of the present disclosure.

### DETAILED DESCRIPTION

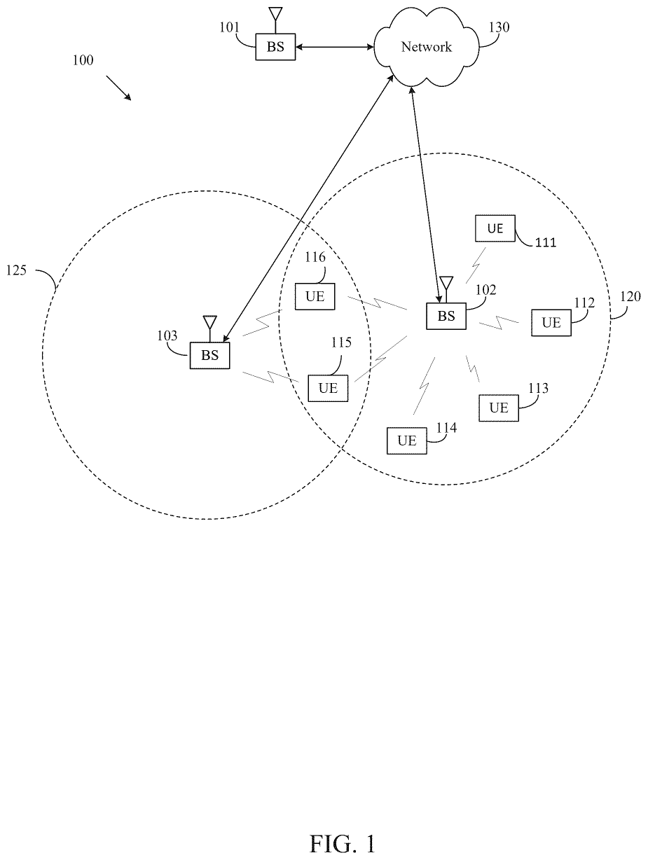

FIG. 1 through FIG. 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v18.2.0, “NR; Physical channels and modulation” [REF1]; 3GPP TS 38.212 v18.2.0, “NR; Multiplexing and Channel coding” [REF2]; 3GPP TS 38.213 v18.2.0, “NR; Physical Layer Procedures for Control” [REF3]; 3GPP TS 38.214 v18.2.0, “NR; Physical Layer Procedures for Data” [REF4]; 3GPP TS 38.321 v18.1.0, “NR; Medium Access Control (MAC) protocol specification” [REF5]; and 3GPP TS 38.331 v18.1.0, “NR; Radio Resource Control (RRC) Protocol Specification” [REF6].

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, embodiments of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of a wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for UE assisted beam management for beam failure recovery and initial access in a wireless communication system. In certain embodiments, and one or more of the gNBs 101-103 includes circuitry, programing, or a combination thereof, for supporting UE assisted beam management for beam failure recovery and initial access in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

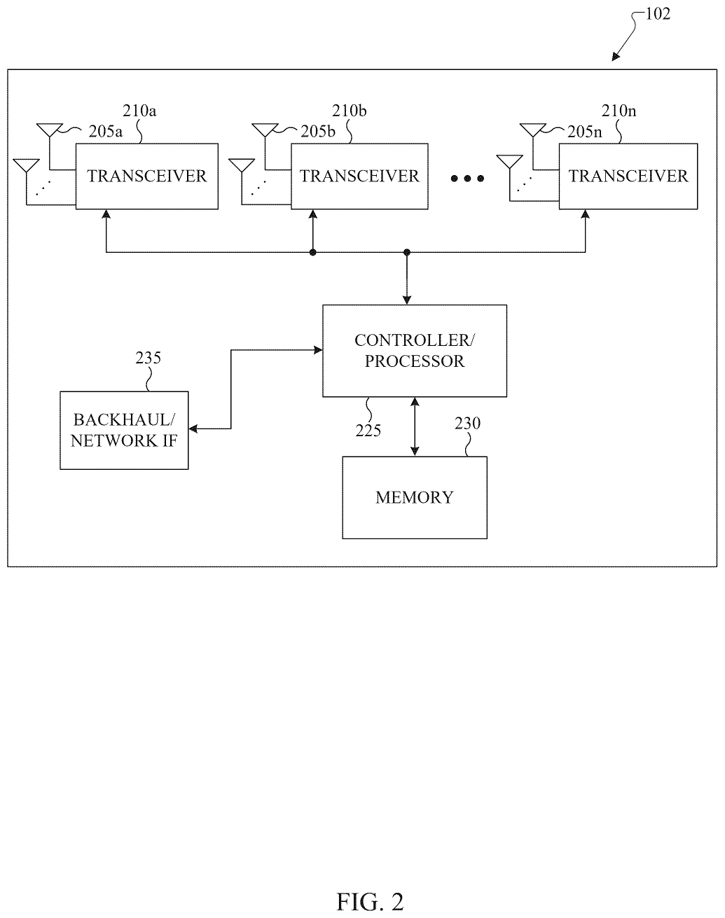

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels or signals and the transmission of DL channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting UE assisted beam management for beam failure recovery and initial access in a wireless communication system. The controller/processor 225 can move data into or out of the memory 230 as executed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

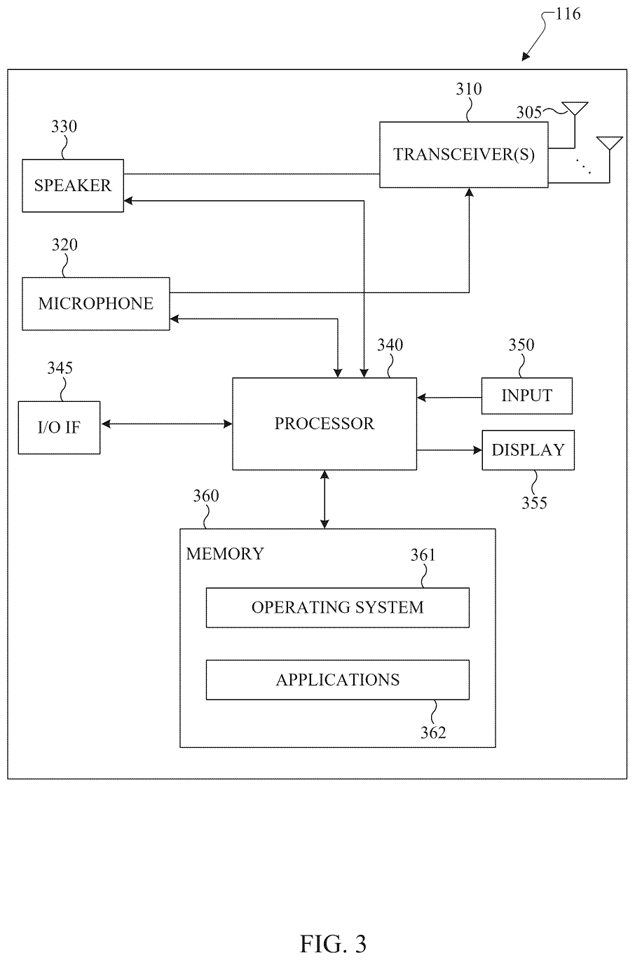

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115), e.g., on a sidelink (SL) channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals, the transmission of UL channels or signals, and reception and transmission of SL channels or signals by the transceiver(s) 310 in accordance with well-known principles. In some embodiments, the processor 340 includes at least one microprocessor or microcontroller. The processor 340 is also capable of executing other processes and programs resident in the memory 360, such as processes for UE assisted beam management for beam failure recovery and initial access in a wireless communication system.

The processor 340 can move data into or out of the memory 360 as provided by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

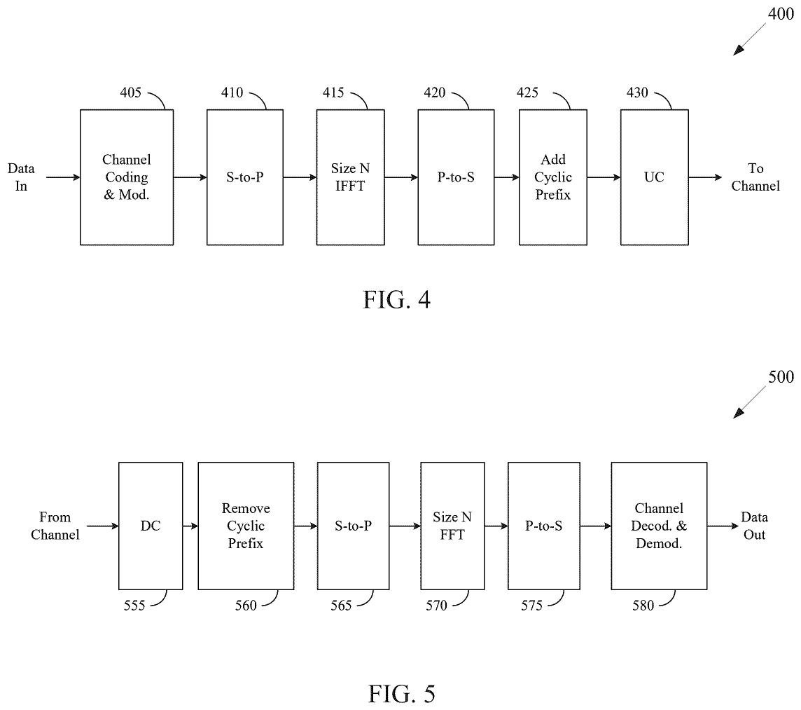

FIG. 4 and FIG. 5 illustrate example wireless transmit and receive paths according to the present disclosure. The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 or another UE arrives at the UE 116 after passing through the wireless channel, and reverse operations to those at the gNB 102 or another UE are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or transmitting in the sidelink to another UE and may implement the receive path 500 for receiving in the downlink from the gNBs 101-103 or receiving in the sidelink from another UE. In some embodiments, the transmit path 400 and/or receive path 500 is configured to support UE assisted beam management for beam failure recovery and initial access in a wireless communication system as described in embodiments of the present disclosure.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

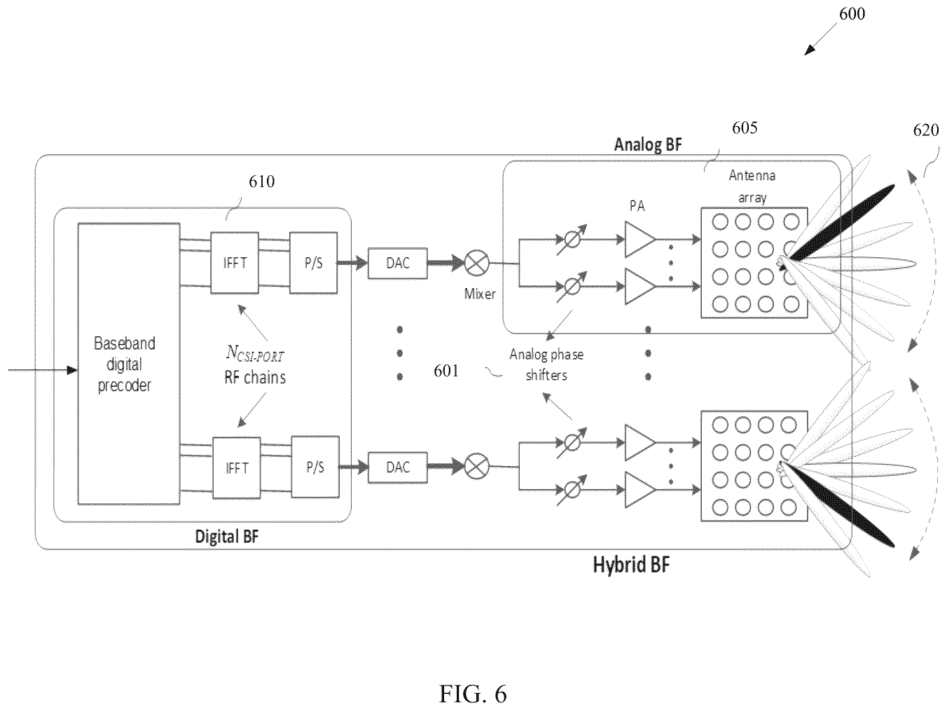

FIG. 6 illustrates an example of antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting,” respectively), and receiving a DL or UL or SL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be used to compensate for the additional path loss.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

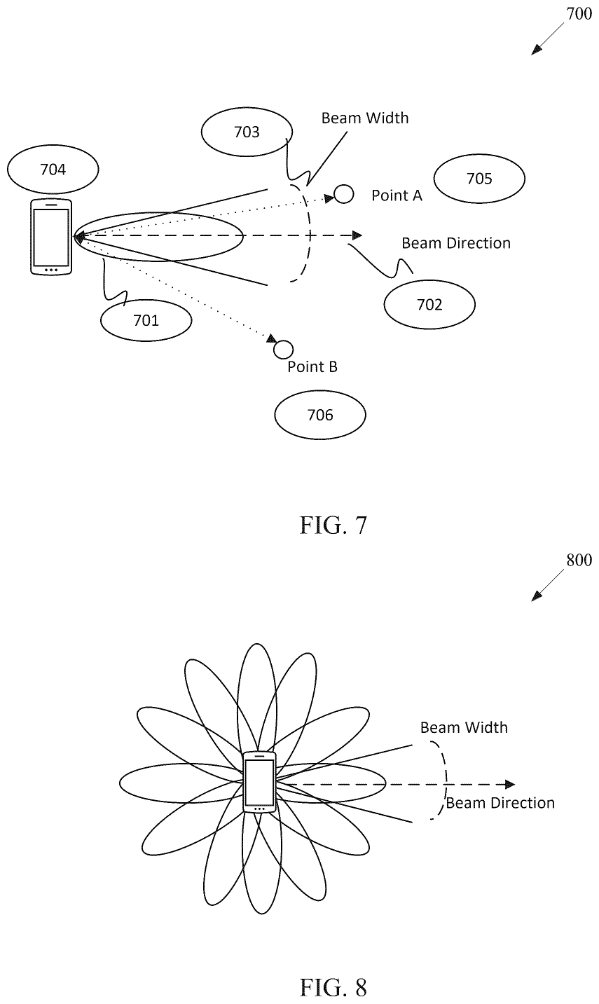

FIG. 7 illustrates an example of a beam 700 in a wireless communication system according to embodiments of the present disclosure. An embodiment of the beam 700 shown in FIG. 7 is for illustration only.

As illustrated in FIG. 7, in a wireless system a beam (701), for a device (704), can be characterized by a beam direction (702) and a beam width (703). For example, a device (704) transmits radio frequency (RF) energy in a beam direction and within a beam width. A device (704) receives RF energy in a beam direction and within a beam width. As illustrated in FIG. 7, a device at point A (705) can receive from and transmit to device (704) as Point A is within a beam width and direction of a beam from device (704). As illustrated in FIG. 7, a device at point B (706) cannot receive from and transmit to device (704) as Point B is outside a beam width and direction of a beam from device (704). While FIG. 7, for illustrative purposes, shows a beam in 2-dimensions (2D), it should be apparent to those skilled in the art, that a beam can be in 3-dimensions (3D), where the beam direction and beam width are defined in space.

FIG. 8 illustrates an example of multi-beams 800 in a wireless communication system according to embodiments of the present disclosure. An embodiment of the multi-beams 800 shown in FIG. 8 is for illustration only.

In the present disclosure, a beam can be determined by any of: (1) a TCI state, that establishes a quasi-colocation (QCL) relationship or spatial relation between a source reference signal (e.g., SS/PBCH Block (SSB) and/or Channel State Information-Reference signal (CSI-RS)) and a target reference signal and (2) a spatial relation information that establishes an association to a source reference signal, such as SSB or CSI-RS or sounding reference signal (SRS). In either case, the ID of the source reference signal or the TCI state or TCI state ID or the spatial relation or spatial relation ID identifies the beam.

The TCI state and/or the spatial relation reference RS can determine a spatial Rx filter or quasi-co-location information for reception of downlink and/or sidelink channels at the UE, or a spatial Tx filter for transmission of uplink and/or sidelink channels from the UE. The TCI state and/or the spatial relation reference RS can determine a spatial Tx filter for transmission of downlink channels from the gNB, or a spatial Rx filter or quasi-co-location information for reception of uplink channels at the gNB.

In a wireless system, a device can transmit and/or receive on multiple beams. This is known as “multi-beam operation” and is illustrated in FIG. 8. While FIG. 8, for illustrative purposes, a beam is in 2D, it should be apparent to those skilled in the art, that a beam can be 3D, where a beam can be transmitted to or received from any direction in space.

Rel-17 introduced the unified TCI framework, where a unified or main or indicated TCI state is signaled to the UE. The unified or main or indicated TCI state can be one of: (i) in case of joint TCI state indication, wherein a same beam or port/PG is used for DL and UL channels, a joint TCI state that can be used at least for UE-dedicated DL channels and UE-dedicated UL channels; (ii) in case of separate TCI state indication, wherein different beams or ports/PGs are used for DL and UL channels, a DL TCI state that can be used at least for UE-dedicated DL channels; and/or (iii) in case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and all of dedicated PUCCH resources.

The unified TCI framework also applies to intra-cell beam management, wherein the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation can be quasi-location with respect to one or more of the following relations (e.g., 3GPP standard specification, TS 38.214): (i) Type A, {Doppler shift, Doppler spread, average delay, delay spread}; (ii) Type B, {Doppler shift, Doppler spread}; (iii) Type C, {Doppler shift, average delay}; and (iv) Type D, {Spatial Rx parameter} or port/PG.

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g., non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g., format 0_1 or 0_2), or a purpose designed DCI format for beam (TCI state) indication, wherein the DCI format includes a “transmission configuration indication” field that includes/indicates a TCI state code point out of the TCI state code points activated by a MAC CE. A DL related DCI format (or an UL related DCI format or purpose designed channel or DCI format for beam (TCI state) indication) can be used to indicate a TCI state when the UE is activated with more than one TCI state code points. The DL related DCI format can be with a DL assignment for PDSCH reception or without a DL assignment. Likewise, the UL related DCI format can be with a UL grant for PUSCH transmission or without an UL grant. A TCI state can also be indicated in a purpose designed channel or DCI Format for TCI state indication. A TCI state (TCI state code point) indicated/included in a DL related DCI format or UL related DCI format or purpose designed channel or DCI format for beam (TCI state) indication is applied after a beam application time from the corresponding HARQ-ACK feedback.

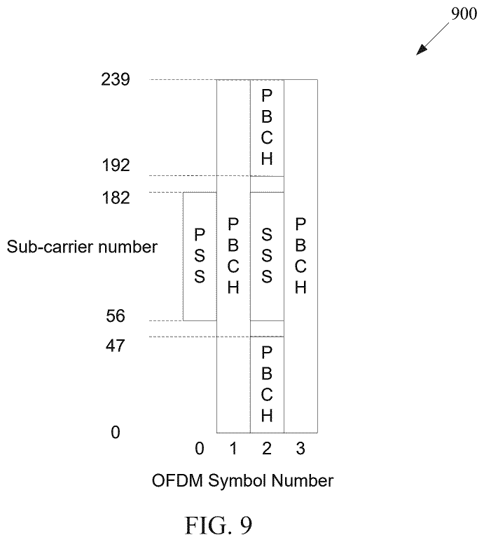

In 5G/NR, a UE performs the cell search procedure to acquire time and frequency synchronization with a cell and to detect the physical layer cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and consists of 4 consecutive symbols, and 20 physical resource blocks (240 subcarriers), as illustrated in FIG. 9.

FIG. 9 illustrates an example of a Synchronization Signal/Physical Broadcast Channel (SS/PBCH) Block 900 according to embodiments of the present disclosure. An embodiment of the OFDM symbol 900 shown in FIG. 9 is for illustration only.

SSBs are organized in groups or bursts of up to N SSBs, transmitted within half a frame, each SSB within the group has an index i, where i=0, 1, . . . , N−1, within each group or burst of SSBs, the SSBs are time-division multiplexed and arranged in increasing order of i, with increasing time. For carrier frequencies less than or equal to 3 GHZ, N=4. For carrier frequencies in FR1 that are larger than 3 GHZ, N=8. For carrier frequencies in FR2, N=64. The SSB indices transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and does not have uplink resources. For example, the physical random access channel can be used during initial access. The PRACH consists of a preamble format comprising one or more preamble sequences transmitted in a PRACH Occasion (RO).

NR supports four different preamble sequence lengths: (i) sequence length 839 used with sub-carrier spacings 1.25 kHz and 5 kHz with unrestricted or restricted sets; (ii) sequence length 139 used with sub-carrier spacings 15 kHz, 30 kHz, 60 kHz and 120 kHz with unrestricted sets; (iii) sequence length 571 used with sub-carrier spacing 30 kHz with unrestricted sets; and (iv) sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of resource blocks (RBs)) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex as illustrated in 3GPP TS 38.211.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛, ¼, ½, 1, 2, 4, 8, 16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order (e.g., 3GPP TS 38.213): (i) first, in increasing order of preamble indexes within a single PRACH occasion; (ii) second, in increasing order of frequency resource indexes for frequency multiplexed PRACH occasions; (iii) third, in increasing order of time resource indexes for time multiplexed PRACH occasions within a PRACH slot, and (iv) fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

There are two types of random access procedures, type-1 random access procedure and type-2 random access procedure.

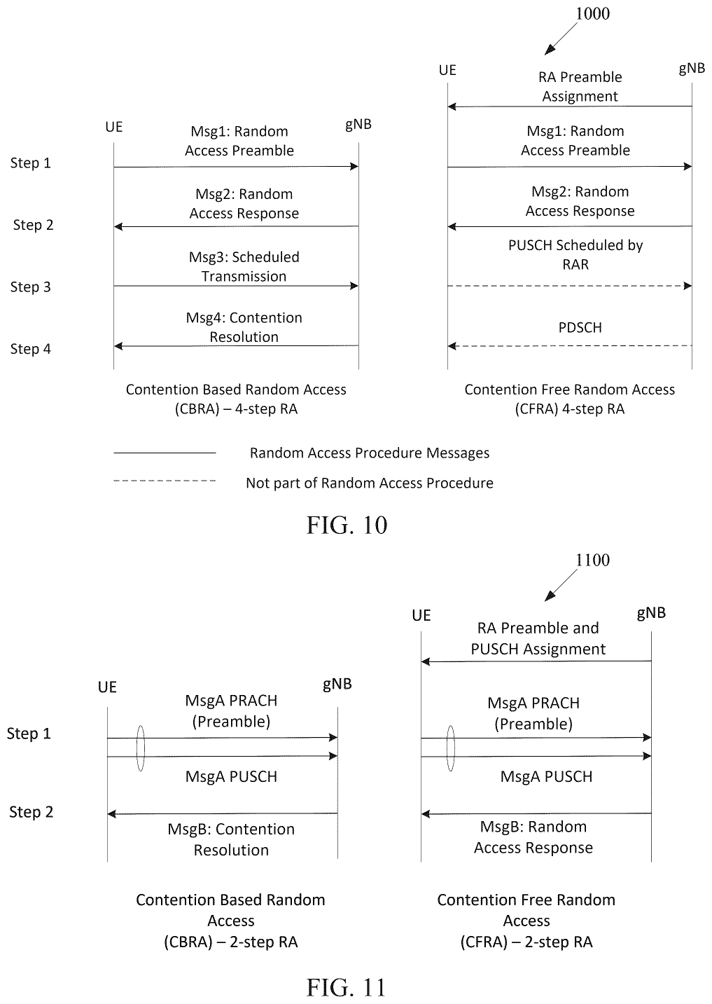

FIG. 10 illustrates an example of Type-1 random access procedure 1000 according to embodiments of the present disclosure. An embodiment of the Type-1 random access procedure 1000 shown in FIG. 10 is for illustration only.

Type-1 random access procedure also known as four-step random access procedure (4-step RACH), is as illustrated in FIG. 10.

As illustrated in FIG. 10, in step 1, the UE transmits a random access preamble, also known as Msg1, to the gNB. The gNB attempts to receive and detect the preamble.

In step 2, the gNB upon receiving the preamble transmits a random access response (RAR), also known as Msg2, to the UE including, among other fields, a time adjustment (TA) command and an uplink grant for a subsequent PUSCH transmission.

In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC or setup request message.

In step 4, the gNB upon receiving the RRC setup request message, allocates downlink and uplink resources that are transmitted in a downlink PDSCH transmission to the UE. After the last step, the UE can proceed with reception and transmission of data traffic.

A Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

FIG. 11 illustrates an example of Type-2 random access procedure 1100 according to embodiments of the present disclosure. An embodiment of the Type-2 random access procedure 1100 shown in FIG. 11 is for illustration only.

Rel-16 introduced a new random access procedure, a Type-2 random access procedure, also known as 2-step random access procedure (2-step RACH), as illustrated in FIG. 11, that combines the preamble and PUSCH transmission into a single transmission from the UE to the gNB, which is known as MsgA. Similarly, the RAR and the PDSCH transmission (e.g., Msg4) are combined into a single downlink transmission from the gNB to the UE, which is known as MsgB.

A random access procedure can be triggered for initial access from the RRC IDLE state. During this procedure, a UE identifies an SS/PBCH block with index i and with an RSRP that exceeds a threshold. The RSRP threshold for SSB selection for RACH resource association is indicated or configured by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH.

If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided with a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

In NR/5G, as a UE in RRC_CONNECTED mode moves around, the UE can connect to the network through different cells or different beams. There are two types of network controlled mobility procedures for UEs in RRC_CONNECTED mode: (1) cell level mobility, also referred to as handover, that performs an RRC signaling operation to be triggered and the UE changes its serving cell from a source serving cell to a target serving cell, and (2) beam level mobility, that includes intra-cell beam level mobility and inter-cell beam level mobility and does not perform an explicit RRC signaling to be triggered.

To improve handover procedures, 3GPP introduced several handover enhancements which include: (i) a dual active protocol stack (DAPS): the source gNB connection is maintained, i.e., a UE continues DL data reception from the source gNB and UL data transmission to the source gNB, after reception of the RRC message for handover, and until the source gNB is released after successful random access to the target gNB; (ii) conditional handover (CHO): RRC configures handover parameters, however, the handover procedure is not executed by the UE until certain condition(s) are met at the UE. The UE evaluates the execution condition(s) upon receiving the CHO configuration, and stops evaluating the execution condition(s) once a handover is executed; and (iii) L1/L2 triggered mobility (LTM). The gNB prepares and provides candidate cell(s) configuration(s) to the UE. The physical layer provides measurement reports that include reference signal received power (RSRP) of SS/PBCH blocks of candidate cell(s). Based on the measurement reports, the gNB can change the serving cell to a target cell through a cell switch command signaled via MAC CE. The UE switches to the target cell following the cell switch command. The benefit of cell switch command is to reduce handover latency.

NR devices (e.g., UE or gNB) can support radio access technology (RAT) independent positioning schemes and RAT dependent positioning schemes. RAT independent positioning schemes include global navigation satellite systems (GNSS), WLAN (e.g., WiFi), Bluetooth, terrestrial beacon system (TBS), as well as sensors within the UE such as accelerometers, gyroscopes, magnetometers, etc. Some of the UE sensors are also known as inertial measurement unit (IMU). NR/5G RAT dependent positioning schemes can use the Uu interface (UL/DL interface) and/or the PC5 interface (SL interface). An NR device (e.g., UE or gNB), can obtain timing information from the received signal, for example using GNSS an NR device can obtain global timing information.

In the DL, positioning reference signal (PRS) can be transmitted by a gNB to a UE to enable the UE to perform positioning measurements. In the UL, a UE can transmit positioning sounding reference signal (SRS) to enable a gNB to perform positioning measurements. UE measurements for positioning include; DL PRS reference signal receive power (DL PRS RSRP), DL PRS reference signal received path power (DL PRS-RSRPP), DL reference signal time difference (DL RSTD), UE Rx-Tx time difference, DL reference signal carrier phase (DL RSCP), DL reference signal carrier phase difference (DL RSCPD), NR enhanced cell ID (E-CID) DL SSB radio resource management (RRM) measurement, and NR E-CID DL CSI-RS RRM measurement. NG-RAN measurements for positioning include; UL SRS reference signal received power (UL SRS-RSRP), UL SRS reference signal received path power (UL SRS-RSRPP), UL relative time of arrival (UL-RTOA), UL angle of arrival (UL AoA), gNB Rx-Tx time difference, and UL reference signal carrier phase (UL RSCP). NR introduced several radio access technology (RAT) dependent positioning methods; time difference of arrival based methods such DL time difference of arrival (DL-TDOA) and UL time difference of arrival (UL TDOA), angle based methods such as UL angle of arrival (UL AoA) and DL angle of departure (DL AoD), multi-round trip time (RTT) based methods, carrier phase based methods and E-CID based methods.

In the SL, SL positioning reference signal (SL PRS) can be transmitted by a first UE to enable a second UE to perform SL positioning measurements. SL positioning measurement includes: SL PRS reference signal received power (SL PRS-RSRP), SL PRS reference signal received path power (SL PRS-RSRPP), SL relative time of arrival (SL-RTOA), SL reference signal time difference (SL RSTD), SL angle of arrival (SL AoA) and SL Rx-Tx time difference.

The present disclosure considers a group of UEs moving together, the UE can be part of a closed subscriber group, or can be configured to be part of a group. A first UE can provide assistance for beam management operations to a second UE. For example, assistance can be provided to establish a link on the second UE, or assistance can be provided in case of beam failure recovery.

FIG. 12 illustrates an example of group communication 1200 according to embodiments of the present disclosure. An embodiment of the group communication 1200 shown in FIG. 12 is for illustration only.

A group of UEs can be associated together, in one example, the group of UEs can include a phone, head-mount device, smart watch, smart ring, smart clothes and other wearables that form a group as illustrated in FIG. 12. One device in the group such as the phone, can provide assistance to initiate/setup, maintain or recover other links to other devices in the group, for example this assistance can be for beam management operations. For example, the UE assisting with beam management operations (e.g., link establishment or beam failure detection and recovery) can have a better quality link to the network. In one example, the UE assisting with beam management can be operating in frequency band with more favourable RF conditions than the other UE being assisted. In one example, the UE assisting with beam management can be operating with large antennas or antenna panels and hence has more favourable RF conditions than the other UE being assisted. In one example, the UE assisting with beam management can be operating with larger transmit power (e.g., has a large power source), or has a more sensitive receiver, and hence has favourable RF conditions than the other UE being assisted.

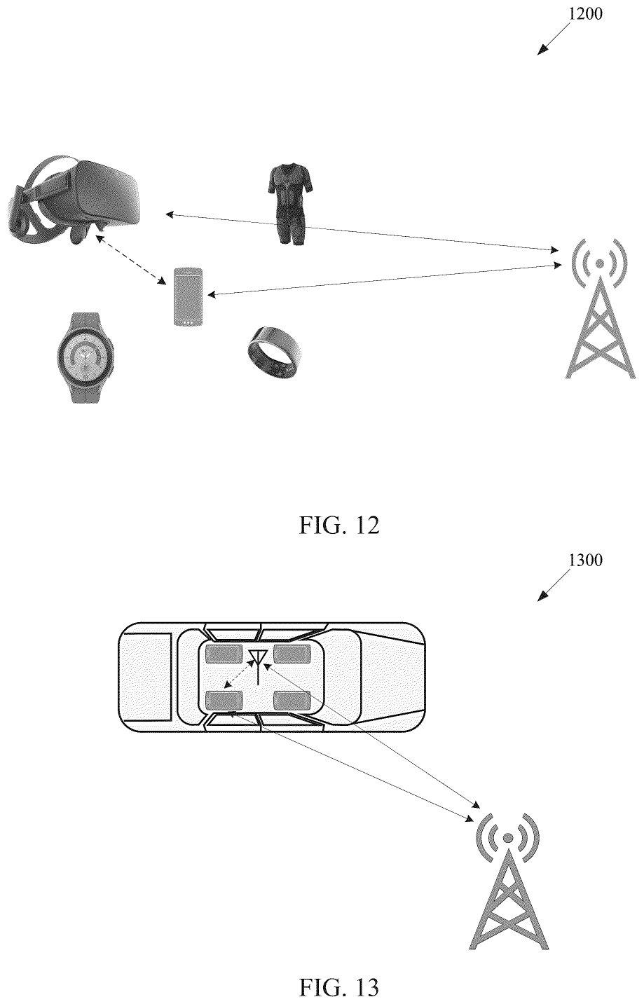

FIG. 13 illustrates an example of group communication including a vehicle 1300 according to embodiments of the present disclosure. An embodiment of the group communication including a vehicle 1300 shown in FIG. 13 is for illustration only.

In another example, the group of devices can be a group of devices traveling together. In one example, the group of devices can include a device associated with a vehicle (e.g., vehicular UE or vUE) the devices are traveling in, the vUE can be connected to a vehicle mounted antenna that provide better link quality or more reliable coverage. This is illustrated by way of example in FIG. 13. One of the devices of the group, e.g., vUE, or another UE in the group, can provide assistance to initiate/setup, maintain or recover other links to other devices in the group, for example this assistance can be for beam management operations.

In one example, the links to the network of the devices in the group can be on the same frequency (e.g., carrier frequency or bandwidth part (BWP) or component carrier (CC)) or frequency band or frequency range. In another example, the links to the network of the devices in the group can be on different frequencies (e.g., carrier frequency or BWP or CC), or different frequency bands or different frequency ranges.

In one example, the devices of a group of UEs can be connected together by a wireless interface. Assistance information can be exchanged across the wireless interface whereby a first device of the group of UEs can provide assistance to a second device of the group of UEs to initiate/setup, maintain or recover a link to the network associated with the second device. In one example, the link between devices can be a sidelink (e.g., using the LTE SL protocol or using the NR SL protocol). In one example, the link between devices is based on a non-3GPP air interface. In one example, the link between devices is a Bluetooth link. In one example, the link between devices is a WiFi link.

In the present disclosure, the signalling and procedures are provided, whereby a first UE in a group of UEs can assist a second UE in the group of UEs to establish a radio link.

The present disclosure relates to a 5G/NR and/or 6G communication system.

The present disclosure includes embodiments related to design of UE assisted beam management, wherein a first UE can assist with initial access of a second UE. This includes: (i) triggering transmission of reference signals for beam management for initial access with assistance from first UE; (ii) reference signals for initial access transmitted by the network or by second UE; and (iii) procedure to identify a beam pair between the gNB and second UE based on assistance provided by first UE.

In the following, both frequency division duplex (FDD) and time division duplex (TDD) are considered as a duplex method for DL and UL signaling. In addition, full duplex (XDD) operation is possible, e.g., sub-band full duplex (SBFD) or single frequency full duplex (SFFD).

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

The present disclosure considers several components that can be used in conjunction or in combination with one another, or can operate as standalone schemes.

In the present disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In the present disclosure, MAC CE signaling can be UE-specific e.g., to one UE or can be UE common (e.g., to a group of UEs or all UEs of a cell). MAC CE signaling can be DL MAC CE signaling or UL MAC CE signaling.

In the present disclosure, L1 control signaling includes: (1) DL control information (e.g., DCI on PDCCH or DL control information on PDSCH) and/or (2) UL control information (e.g., UCI on physical uplink control channel (PUCCH) or PUSCH). L1 control signaling be UE-specific e.g., to one UE or can be UE common (e.g., to a group of UEs to all UEs of a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In the present disclosure, a list with N elements can be denoted as L (i), where i can take N values, and L (i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise define in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to the same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the necessary information to assign a particular DL (or/and UL) TX beam to the UE, for example in case of channel reciprocity.

In the present disclosure, a beam management reference signal reference refers to a reference signal, a UE can use for beam management procedure. A beam management procedure can include: (i) initial beam acquisition for identifying a beam or a beam pair between two devices (e.g., UE and gNB/TRP or between two UEs) during channel setup or link establishment. This includes initial beam sweeping to identify a beam pair between two UEs. This can also include identifying a beam or a beam pair between a UE and new gNB/TRP in case of handover; (ii) beam maintenance for refining and tracking the beam as the UE moves around or the channel conditions change. This includes beam measurement and reporting, and beam indication signaling; and (iii) beam failure detection and recovery, an emergency-only procedure for determining when a beam has failed, and identifying a new beam to use instead. Beam failure events are typically rare and, in the unlikely event that a beam fails, beam recovery should be fast and before the link fails.

A beam management reference signal can include: (i) a SS/PBCH block, which includes one or more synchronization signals carrying a cell ID (or a gNB/TRP ID or a RU ID), and a channel carrying minimum system information or part of the minimum system information, wherein the minimum system information is the information requested by the UE to access the network. In one example, the SS/PBCH block is not associated with PCI. In one example, the SS/PBCH is associated with PCI. In one example, the SS/PBCH block is a non-cell defining (NCD) SS/PBCH block. In one example, the SS/PBCH block is a cell defining (CD) SS/PBCH block; (ii) LP-SS (low power synchronization signal), which includes one or more synchronization signals carrying a cell ID (or a gNB/TRP ID or a RU ID). In one example, a LP-SS can be received by a low power receiver in the UE. In one example, the LP-SS is not associated with PCI. In one example, the LP-SS is associated with PCI; (iii) channel state information reference signal (CSI-RS). In one example, the CSI-RS is not associated with a PCI. In one example, the CSI-RS has no source RS, e.g., the CSI-RS is the root of the QCL relation. In one example, the CSI-RS is QCLed to another CSI-RS. In one example, the CSI-RS is QCLed to a SS/PBCH block. In one example, the CSI-RS is QCLed with LP-SS. In one example, the CSI-RS is associated with a PCI. In one example, the CSI-RS has one antenna port. In one example, the CSI-RS has more than one antenna port; (iv) sounding reference signal (SRS); and (iv) one of the aforementioned reference signals transmitted on the SL interface.

In one example, the CSI-RS and/or LP-SS and/or SS/PBCH block (e.g., non-cell defining synchronization signal (NCD-SS)/PBCH block) is transmitted from multiple RUs or multiple TRPs with single frequency network (SFN) properties. In one example, the same time and frequency resources and a same sequence is used to transmit CSI-RS and/or LP-SS and/or SS/PBCH block from multiple RUs or from multiple TRPs.

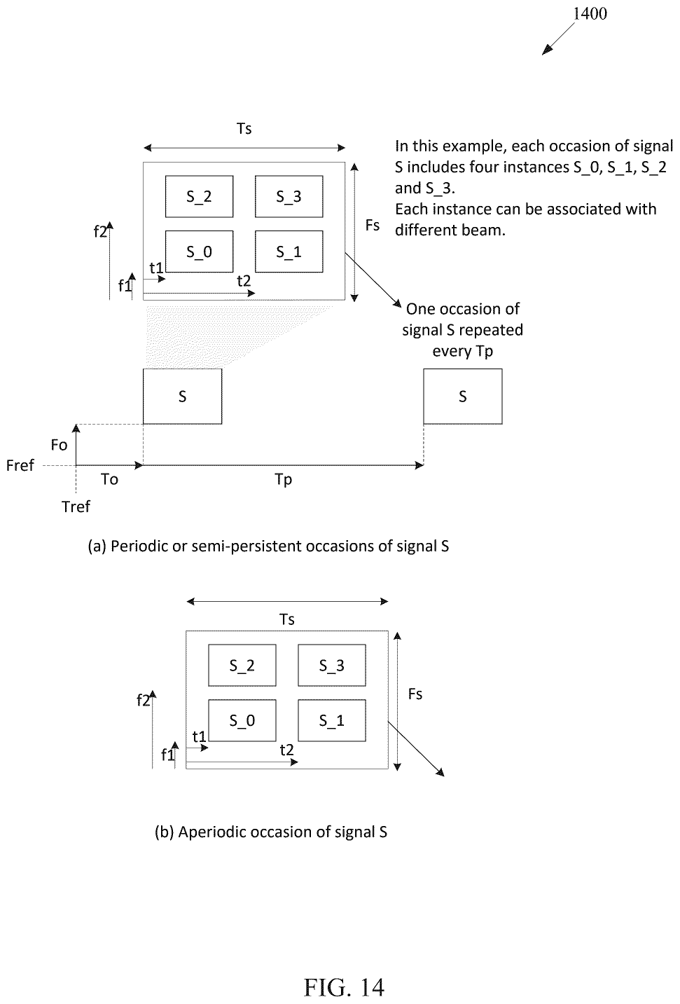

A beam management reference signal, S, can be transmitted, periodically, or semi-persistently or aperiodically. For example, when the beam management reference signal is transmitted periodically, it can include periodic occasions, wherein each periodic occasion or aperiodic occasion includes one or more instances of the reference signal for beam management. An instance of the reference signal for beam management can be determined by a time and/or frequency (and possibly code) resources as illustrated in FIG. 14.

FIG. 14 illustrates an example of periodic and aperiodic occasions of beam management reference signal 1400 according to embodiments of the present disclosure. An embodiment of the periodic and aperiodic occasions 1400 shown in FIG. 14 is for illustration only.

In one example, each instance of the reference signal can be transmitted using a different spatial domain transmission filter (e.g., different transmit beam). The receiver receiving and measuring the beam management reference signal, can measure a quality (e.g., RSRP or RSSI or SINR or RSRQ) for each instance of the reference signal for beam management and identify a corresponding instance of the beam management reference signal, and hence a corresponding spatial domain filter or beam as described later in this disclosure.

In the examples, of this disclosure, the beam management reference signal S, can represent a set of reference signals. An instance of S, as illustrated in FIG. 14, can represent an reference signal of the set of reference signals. In one example, the configuration of S (e.g., set of reference signals) can be configured and/or provided by the gNB and/or the UE assisting with beam management (e.g., link establishment or beam failure detection and recovery) and/or the UE being assisted with beam management (e.g., link establishment or beam failure detection and recovery).

In the example of FIG. 14 (e.g., (a) as illustrated in FIG. 14), signal S is periodic or semi-persistent, occasions of signal S occur at a time period Tp. Each occasion of signal S can include N instances of signal S (e.g., a burst of signal S). In the example of FIG. 14 (e.g., (a) as illustrated in FIG. 14), N=4. Each instance can have its own time and/or frequency (and possibly code or comb) resources. Each instance can be transmitted using a spatial domain filter (or beam) associated with the instance. In one example, different beams can be used for different instances (e.g., for transmit beam sweeping). In one example, the same beam can be used for more than one instance (e.g., for receive beam sweeping).

In the example of FIG. 14 (e.g., (b) as illustrated in FIG. 14), signal S is aperiodic, an aperiodic occasion of signal S can include N instances of signal S. In the example of FIG. 14 (e.g., (b) as illustrated in FIG. 14), N=4. Each instance can have its own time and/or frequency (and possibly code or comb) resources. Each instance can be transmitted using a spatial domain filter (or beam) associated with the instance. In one example, different beams can be used for different instances (e.g., for transmit beam sweeping). In one example, the same beam can be used for more than one instance (e.g., for receive beam sweeping).

In one example of this disclosure, the reference signal for beam management can include more than one reference signal: (i) a first reference signal for beam management e.g., for initial beam acquisition for initial access or channel setup; (ii) a second reference signal for beam management e.g., for initial beam acquisition for mobility (e.g., handover or cell switch); (iii) a third reference signal for beam management e.g., for beam maintenance (e.g., beam tracking and/or beam refinement); (iv) a fourth reference signal for beam management e.g., for beam failure detection or beam failure detection referred to as BFD-RS; and/or (v) a fifth reference signal for beam management e.g., for beam failure recovery or for new beam identification, referred to as NBI-RS.

In one example, more than one of the reference signals mentioned in the present disclosure can be the same. For example, the first and the second reference signals can be the same. For another example, the first and the second and the fourth reference signals can be the same. For another example, the fourth (e.g., BFD-RS) and fifth (e.g., NBI-RS) reference signals can be the same.

In one example, there is one reference signal for beam management. In one example, a reference signal can be used for beam management and for other purposes such as tracking or channel state information (CSI) acquisition.

In one example, the configuration of the reference signal for beam management can be adapted or updated, by RRC signaling and/or MAC CE signaling and/or L1 control signaling.

In one example, the configuration of the beam management reference signal can include at least one of: (i) type of reference signal, e.g., SS/PBCH block, or LP-SS or CSI-RS or SRS; (ii) time and frequency resources (e.g., period Tp and time and frequency (and possibly code or comb) resources of reference signal instances); (iii) sequence for reference signal; and/or (iv) power for reference signal. In one example, the power is an absolute power for each instance. In one example, the power is relative to a relative instance of signal S.

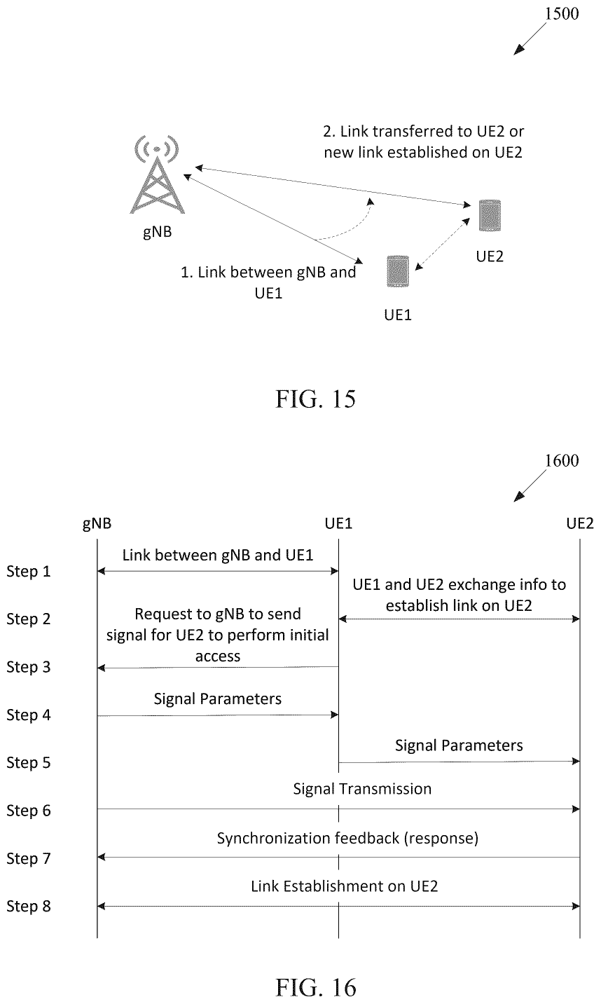

FIG. 15 illustrates an example of link establishment 1500 according to embodiments of the present disclosure. An embodiment of the link establishment 1500 shown in FIG. 15 is for illustration only.

In FIG. 15, a first UE (e.g., UE1) has a link established with the gNB. In one example, the link is transferred to a second UE (e.g., UE2), the UE1 and the UE2 exchange information on the link transfer, and the UE1 assists the UE2 to perform initial access and assists in transferring the link to the UE2 or establishing a new link on UE2, e.g., the UE1 assists in transferring a link from the UE1 to the UE2 or establishing a new link on UE2. In another example, the UE2 wants to establish a new link with the network, the UE1 and the UE2 exchange information, and the UE1 assists the UE2 to perform initial access and assists in establishing a new link on the UE2. In one example, the UE1 and the UE2 can be part of a UE group, e.g., a closed subscriber group. In one example, the link established between the UE2 and the network can be on the same frequency (e.g., carrier frequency or BWP or component carrier (CC)) or frequency band or frequency range as link between the network and the UE1. In another example, the link between the UE2 and the network can be on a different frequency (e.g., carrier frequency or BWP or CC), or different frequency band or different frequency range than the link between the network and the UE1.

FIG. 16 illustrates a signaling flow 1600 of link establishment according to embodiments of the present disclosure. The signaling flow 1600 as may be performed by a UE (e.g., 111-116 as illustrated in FIG. 1). An embodiment of the signaling flow 1600 shown in FIG. 16 is for illustration only. One or more of the components illustrated in FIG. 16 can be implemented in a specialized circuitry configured to perform the noted functions or one or more of the components can be implemented by one or more processors executing instructions to perform the noted functions.

The flow chart as illustrated in FIG. 16 illustrates an example where the UE1 can assist with establishing a link between the network and the UE2. In the example, as illustrated in FIG. 16, the reference signal for initial access or link establishment is transmitted by the gNB. In the example illustrated in FIG. 16, the link between the UE2 and the network is established to the same gNB as the link between the UE1 and the network, however, the link between the UE1 and the network and the link between the UE2 and the network can use different gNBs or TRPs, a similar procedure is used, but it is understood that internal signaling within the network can be used to establish the link between the network and the UE2 on a gNB different from the gNB used for the UE1.

In the example of FIG. 16, a link has been established between the gNB and a first UE (e.g., UE1). The UE1 identifies a second UE (e.g., UE2), and the link is to be transferred to the UE2 or a new link is to be established on UE2. The UE1 and the UE2 exchange information to assist in the transfer of the link to the UE2 or establishing a new link. In one example of FIG. 16, a second UE (e.g., UE2) wants to establish a link with the gNB. The UE2 identifies a first UE (e.g., UE1), with a link established with the gNB. The UE1 and the UE2 exchange information to assist in establishing a new link on the UE2 with the gNB. In one example of FIG. 16, a first UE (e.g., UE1) with a link established with the gNB, identifies a second UE (e.g., UE2) to establish a link with the gNB. The UE1 and the UE2 exchange information to assist in establishing a new link on the UE2 with the gNB. In one example, of the aforementioned examples, the gNB to which the UE2 establishes a link is the same as the gNB to which the UE1 has a link established. In one example, of the aforementioned example, the gNB to which the UE2 establishes a link is the different from the gNB to which the UE1 has link established.

As illustrated in FIG. 16, in step S1, the UE1 has a link established with the network. In step S2, a link is to be transferred or a new link established on the UE2, the link between the UE2 and the network can be on the same frequency (e.g., carrier frequency or BWP or CC), a frequency band or a frequency range as link between the network and the UE1. In another example, the link between the UE2 and the network can be on a different frequency (e.g., carrier frequency or BWP or CC), or different frequency band or different frequency range than the link between the network and the UE1.

In one example, the information exchange is on SL interface (e.g., PC5 interface), e.g., using NR SL protocol or using LTE SL protocol. In one example, the information exchange is on a non-3GPP interface such as WiFi or Bluetooth. In one example, the UE1 sends a request to the UE2 to accept a link transfer or a new link. In one example, the UE2 sends a request to the UE1 to have a link transferred to the UE2 or a new link established on the UE2. In one example, the UE2 provides the UE1 with information to assist with link establishment on the UE2. In one example, the UE2 provides the UE1 with information to assist with a link transfer or link establishment on the UE2. In one example, the UE2 provides UE2's positioning information to assist with a link transfer or link establishment on the UE2. In one example, positioning information can include radio access technology (RAT)-dependent positioning information, e.g., positioning measurements. In one example, positioning information can include radio access technology RAT-independent positioning information. In one example, positioning information can include positioning measurements on the Uu interface and/or positioning measurements on the SL. In one example, positioning information includes location information, e.g., co-ordinates in a global co-ordinate system or co-ordinates in a local co-ordinate system.

In one example, a gNB transmits a reference signal for initial access continuously (e.g., periodically with periodic occasions), wherein the reference signal is as aforementioned. In one example, a gNB transmits a reference signal for initial access on demand. In step S3 of FIG. 16, the UE1 sends a request to the gNB to initiate link establishment on the UE2, e.g., the network (the gNB of UE1 or another gNB(s)) transmit a reference signal to assist the UE2 to perform initial access. In one example, the request can include positioning information for the UE2, to assist the network in determining the gNB(s) and/or the spatial domain filters (beams) to use to transmit the reference signal. In one example, after the gNB receives the signal from the UE1, the gNB transmits an acknowledgment or feedback. In one example, the acknowledgment or feedback can be a DCI format or MAC CE or ASN.1 message. In one example, if the UE1 does not receive the acknowledgment or feedback, the UE1 (re-)transmits the request to the gNB to initiate link establishment on the UE2.

The network determines a signal S to transmit to assist with link establishment or initial access on the UE2 (e.g., beam identification for the link between the gNB and the UE2, can also assist with timing advance (TA) determination). In one example, signal S are reference signals or a set of reference signals for link establishment or initial access for UE2. In one example, S is a synchronization signal/physical broadcast channel (SS/PBCH) Block, referred to an SSB. In one example, S is a channel state information reference signal (CSI-RS). In one example, S is a PDSCH. In one example, S is a PDSCH DMRS. In one example, S is PDCCH. In one example, S is a PDCCH DMRS. In one example, S can be LP-SS as aforementioned. In one example, signal S can be as illustrated in FIG. 14 (e.g. (a) or (b) as illustrated in FIG. 14).

The parameters of signal S can include (i) time related parameters, including, whether the signal is periodic, semi-persistent or aperiodic with one-shot transmission or N shot transmissions, time of transmission (e.g., symbol and/or slot and/or sub-frame and/or frame). Time of transmission can be an absolute time, or a relative time relative to a second signal or channel (e.g., signal A as discussed later in this disclosure). Time related parameters can also include periodicity of signal S and offset within periodicity. Time related parameters can also include number of transmission instances of signal S for each occasion of signal S. Time related parameters can also include number of transmission occasions of signal S. Time related parameters can also include duration of signal S (e.g., in number of symbols or slots), and time related parameters for each instance of signal S of a transmission occasion of signal S; (ii) frequency related parameters, including size in frequency domain (e.g., number of PRBs or number of sub-carriers or number of sub-channels), starting positioning in frequency domain (e.g., starting PRB or starting sub-carrier or starting sub-channel), location of sub-carriers within a PRB, whether a comb-structure is used and the comb size and comb offset, BWP used for signal S, carrier used for signal S. Frequency band of signal S. Frequency region of signal S. Frequency related parameters (including comb if applicable) for each instance of signal S of a transmission occasion of signal S; and (iii) code related parameters, such as scrambling sequence index, pseudo random sequence index and orthogonal cover index if applicable. Code related parameters for each instance of signal S of a transmission occasion of signal S if applicable.

Signal A can be one of the following: (i) signal transmitted from the UE1 to the gNB in step 3 of FIG. 16 to request link establishment for the UE2; (ii) acknowledgment or feedback to signal transmitted from the UE1 to the gNB in step 3 of FIG. 16 to request link establishment for the UE2; (iii) signal transmitted in step 4 of FIG. 16 with information about signal S; and/or (iv) acknowledgement or feedback to signal transmitted in step 4 of FIG. 16 with information about signal S.

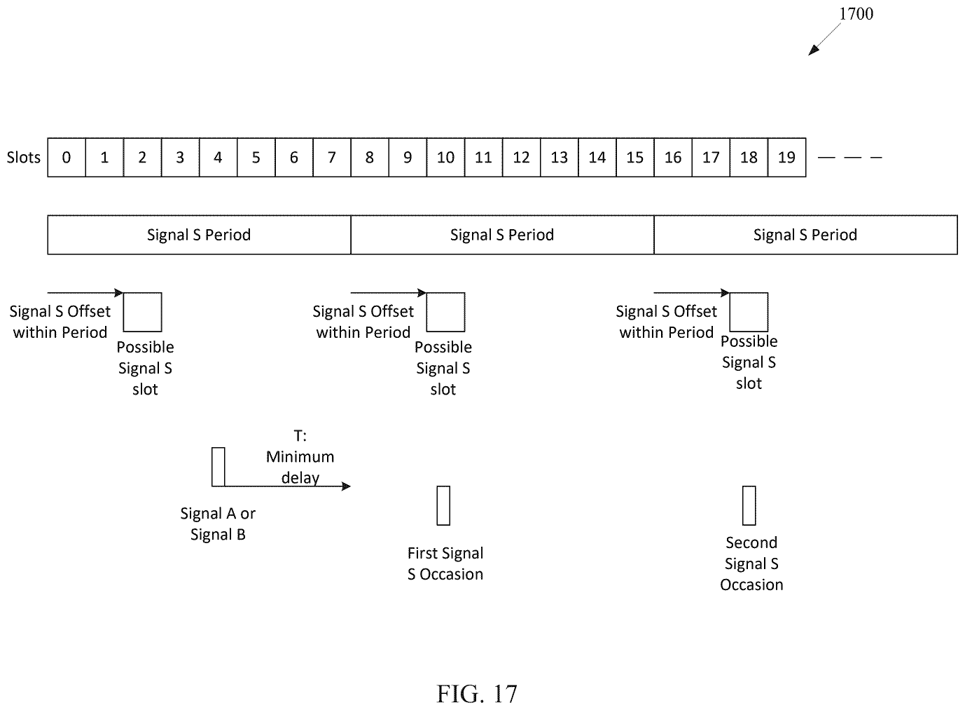

FIG. 17 illustrates an example of beam management reference signal S configuration 1700 according to embodiments of the present disclosure. An embodiment of the signal S configuration 1700 shown in FIG. 17 is for illustration only.

In one example, signal S can be transmitted at or after a time T from the end (or start) signal A. In one example, the slot or subframe or frame used to transmit signal S can be (or can start) at least a time T after the end (or start) of signal A. In one example, the slot or subframe or frame used to transmit signal S is the first slot or subframe or frame that starts at or after a time T from the end (or start) of signal A and optionally based on an offset and a periodicity as illustrated in FIG. 17. Wherein, the time T can be defined in the system specifications and/or configured or updated by the network (e.g., using SIB signaling and/or RRC signaling and/or MAC CE signaling and/or L1 control signaling).

FIG. 17 illustrates an example of signal S configuration, wherein a signal S period is configured (e.g., 8 slots) and a signal S offset within the signal S period for the S-signal slots is configured (e.g., 2 slots). In one example, each occasion of signal S can include multiple instances (e.g., a burst of instances), e.g., transmitted on different beams, as illustrated in FIG. 17. The configuration of the signal S offset and signal S period can be by SIB configuration or by RRC configuration. The signal S period and the signal S offset determine the potential (possible) signal S transmission occasions. At or after a delay T from a signal A the signal S can be transmitted. A first occasion of signal S is transmitted in the earliest (first) potential signal S occasion (as determined by the period and offset) occurring at or after a time T from signal A as illustrated in FIG. 17. In FIG. 17, signal S is transmitted in two occasions. In one example, time T is measured from the start signal A. In one example, time T is measured from the end signal A. T can be configured by RRC signaling and/or MAC CE signaling and/or L1 control signaling.

In one example, the gNB determines the parameters of signal S.

In step S4 of FIG. 16, the gNB provides information related to the parameters of signal S, as aforementioned, to the UE1. In one example, the gNB provides a configuration of reference signals or a set of reference signals for link establishment or initial access for UE2. In one example, after the UE1 receives the signal from the gNB with the parameters of signal S, the UE1 transmits an acknowledgment or feedback. In one example, the acknowledgment or feedback can be transmitted in a PUCCH or PUSCH. In one example, the acknowledgment or feedback can be a HARQ-ACK. In one example, the acknowledgment or feedback can be a MAC CE or ASN.1 message on PUSCH. In one example, if the gNB does not receive the acknowledgment or feedback, the gNB (re-)transmits the signal providing parameters related to signal S. In one example, there is no signal transmitted from the gNB to provide parameters related to signal S, for example, the parameters can be determined by pre-configuration.

In step S5 of FIG. 16, the UE1 provides information related to the parameters of signal S to the UE2. In one example, the UE1 provides to second UE a configuration of reference signals or a set of reference signals for link establishment or initial access for UE2, e.g., configuration received from gNB in step S4. In one example, steps S4 and/or S5 are not performed and the information related to signal S is determined by an earlier configuration. The UE1 provided information on signal S to the UE2 on a wireless interface between the UE1 and the UE2. In one example, the wireless interface is a SL interface (e.g., PC5 interface), e.g., using NR SL protocol or using LTE SL protocol. In one example, the wireless interface is a non-3GPP interface such as WiFi or Bluetooth.

In step S6 of FIG. 16, the gNB transmits signal S, the UE2 identifies a beam based on an instance signal S to use when communicating with the gNB. In one example, the UE2 identifies a reference signal from the reference signals or from the set of reference signals for link establishment or initial access provided by gNB via the UE1. In one example, transmission of signal S can continue until the gNB receives a message or a signal from the UE2 or an event to deactivate signal S. In one example, transmission of signal S can be for M occasions. In one example, M is 1. In one example, M can be defined in the system specifications. In one example, M can be configured by RRC signaling and/or MAC CE signaling and/or L1 control signaling. In one example, transmission of signal S can be for M occasions or until a message or an event stops signal S. In one example, the UE1 can send a message or signal to the gNB to stop or deactivate the transmission of signal S. In one example, the UE2 can send a message or signal to the gNB to stop or deactivate the transmission of signal S. In one example each occasion of signal S includes N instances as aforementioned. In one example, a UE identifies an instance of signal S based on the signal quality of the instance of S (e.g., quality can be RSRP or RSSI or RSRQ or SINR) for the corresponding instance. e.g., instance of signal S with a quality above a threshold or an instance of signal S with the best (e.g., highest) quality. In one example, an instance of signal S is associated with a beam.

In step S7 FIG. 16, the UE2 transmits a signal or message to the gNB related to or including the beam the UE2 identified (e.g., instance of signal S UE identified) (or reference signal from the reference signals, e.g., S, or from the set of reference signals for link establishment or initial access). This establish a beam pair to use between the UE2 and the gNB. In one example, after receiving the signal or message from the UE2, the gNB can stop transmitting signal S. In one example, if signal S is a periodic signal, after receiving the signal or message from the UE2 in step S7, the gNB stops transmitting periodic signal S. In one example, if signal S has M occasions, and the gNB transmitted less than M occasions, after receiving the signal or message from the UE2 in step S7, the gNB can stop transmitting the remaining occasions. In one example, signal S can also include or be associated with a system information block (SIB). In one example, each instance of signal S is associated with a corresponding instance of a SIB.

In one example, the signal the UE2 transmits in step S7 is random access preamble (PRACH). In one example, the PRACH preamble is contention free random access (CFRA) preamble. In one example, the preamble index and/or the PRACH occasion are provided in the information from the gNB and/or UE1 in step S4 and/or S5, or in the system information block associated with signal S. In one example, in response to the reception of the preamble, the gNB can transmit a random access response (RAR). If the UE2 does not receive the RAR, UE can re-transmit the CFRA preamble. In one example, if the gNB receives the preamble, the gNB stops transmitting signal S. In one example, if the gNB receives message 3 (e.g., message transmitted by a UE and scheduled by the RAR), the gNB stops transmitting signal S. In one example, the UE2 identifies an instance of signal S based on a quality of signal S (e.g., quality can be RSRP or RSSI or RSRQ or SINR), e.g., instance of signal S with a quality above a threshold or an instance of signal S with the best (e.g., highest) quality. In one example, PRACH occasions and/or preamble index is associated with identified instance of signal S (e.g., signal S can be SS/PBCH block or CSI-RS or LP-SS as aforementioned). In one example, PRACH occasions and/or preamble index is associated with the UE2.

In one example, the signal UE2 transmits in step S7 is random access preamble (PRACH). In one example, the PRACH preamble is contention-based random access (CBRA) preamble. In one example, the preamble index (or set of preamble indices to select from) and/or the PRACH occasion (or set of PRACH occasions to selection from) are provided in the information from the gNB and/or the UE1 in step S4 and/or S5, or in the system information block associated with signal S. In one example, in response to the reception of the preamble, the gNB can transmit a random access response (RAR). If the UE2 does not receive the RAR, a UE can re-transmit the preamble or select a new preamble within the set of configured preambles and retransmit it. In one example, a RAR can include a UL grant for an UL transmission from the UE2 (e.g., message 3), in one example, the RAR can include an RNTI. In one example, after receiving the RAR, the UE transmits message 3. In one example, the gNB after receiving the RAR transmits message 4, e.g., for contention resolution. In one example, the UE2 after receiving message 4, transmits a HARQ acknowledgement. In one example, if the gNB receives the HARQ acknowledgment for message 4, the gNB stops transmitting signal S.

In one example, message 4 includes a grant for an uplink transmission from the UE, or the UE receives an uplink grant in a DCI format for an uplink transmission. The UE transmits the corresponding UL message (e.g., message 5). In one example, if the gNB receives message 5, the gNB stops transmitting signal S. In one example, the UE2 identifies an instance of signal S based on a quality of signal S (e.g., quality can be RSRP or RSSI or RSRQ or SINR), e.g., instance of signal S with a quality above a threshold or an instance of signal S with the best (e.g., highest) quality. In one example, PRACH occasions and/or preamble index is associated with identified instance of signal S (e.g., signal S can be SS/PBCH block or CSI-RS or LP-SS as aforementioned). In one example, the UE provides information about identified instance of signal S in PRACH preamble (message 3). In one example, the UE provides information about identified instance of signal S in message 3. In one example, the UE provides information about identified instance of signal S in message 5.

In the aforementioned examples, type-2 random access procedure (2-step RACH) can be used instead of type-1 random access procedure.

In step S8 FIG. 16, after a beam pair has been identified for communication between the gNB and the UE2, a link can be established between the gNB and the UE2. The link can be a transferred link from the UE1 or a new link established on the UE2.

In one example, a first UE (e.g., UE1) has a link established with the gNB. The UE1 provides assistance to a second UE (e.g., UE2) to establish a new link, to a third UE (e.g., UE3) to establish a new link, . . . , and to an (N+1)th UE (e.g., UE (N+1)) to establish a new link. The procedure described in the previous steps can occur in parallel, for each of the N UEs (i.e., UE2, UE3, . . . . UE (N+1)). The links between UE1, UE2, UE3, . . . , UE (N+1) and the network can be on same or different frequencies (e.g., carrier frequencies or BWPs or CCs), or same or different frequency bands or same or different frequency ranges.

In one example, in step S2, each of the N UEs, e.g., UE2, UE3, . . . . UE (N+1), exchange information with the UE1 to assist with the link establishment on the UE2, the UE3, . . . . UE (N+1) respectively. In one example, the information exchange can be initiated by the UE1. In one example, the information exchange can be initiated by the UE2, the UE3, . . . the UE (N+1) respectively. In one example, in step 3, the UE1 can send a request to the network, e.g., gNB, to perform (or initiate) initial access (or link establishment) for each of the UE2, the UE3, . . . the UE (N+1) respectively. In one example, a request message from the UE1 to the network can correspond to (or include information related to) more than one UE of the UE2, the UE3, . . . the UE (N+1), (e.g., all the N UEs). In one example, a separate request message is sent from the UE1 to the network (e.g., containing information) for each of the UE2, the UE3, . . . the UE (N+1).

In one example, in step 4, signal S is transmitted by the network to assist with initial access or link establishment for a UE. The parameters for signal S are provided from the gNB to the UE1 and/or pre-configured. In one example, the parameters for signal S are common to all N UEs (UE2, UE3, . . . . UE (N+1)), e.g., signal S is a super set of signal S for each individual UE. In one example, the parameters for a signal S is provided separately for each of the N UEs (UE2, UE3, . . . . UE (N+1)).

In one example, in step 5, the parameters of signal S are provided from the UE1 to each of the N UEs (e.g., UE2, UE3, . . . . UE (N+1). In one example, the parameters for signal S are common to all N UEs (e.g., UE2, UE3, . . . . UE (N+1)), e.g., signal S is a super set of signal S for each individual UE. In one example, the parameters for a signal S is provided separately for each of the N UEs (e.g., UE2, UE3, . . . . UE (N+1)).

In one example, in step 6, the network e.g., gNB (or gNBs as different gNBs can be used for initial access or link establishment for the different UEs) transmits signal S. In one example, signal S is a super set of set S for initial access or link establishment of each UE. In one example, multiple signal S are transmitted, wherein a signal S can be transmitted for a UE of the N UEs, or for a subset of UEs of the N UEs.

In one example, in step 7, based on the reception signal S at a UEi of the N UEs (UE2, UE3, . . . . UE (N+1)), UEi identifies an instance of reference signal S corresponding to a spatial domain filter (e.g., beam) for communicating with the network.

In one example, in step 8, the UEi provides feedback to the network on the identified beam in step 7, for example, this can be based on a transmission of a PRACH preamble or another UL channel or signal that can include or indicate the identified instance of signal S (e.g., beam) and/or the UE. In one example, the network (e.g., gNB(s)) can respond to the UEi feedback as aforementioned in this disclosure. In one example, the network (e.g., gNB(s)) can stop transmission of a signal S (or part of a signal S) corresponding to a UEi when receiving feedback (e.g., PRACH preamble or another UL channel or signal) from UEi. In one example, the network (e.g., gNB(s)) can stop transmission of a signal S when receiving feedback (e.g., PRACH preamble or another UL channel or signal) from all N UEs (e.g., UE2, UE3, . . . . UE (N+1)).

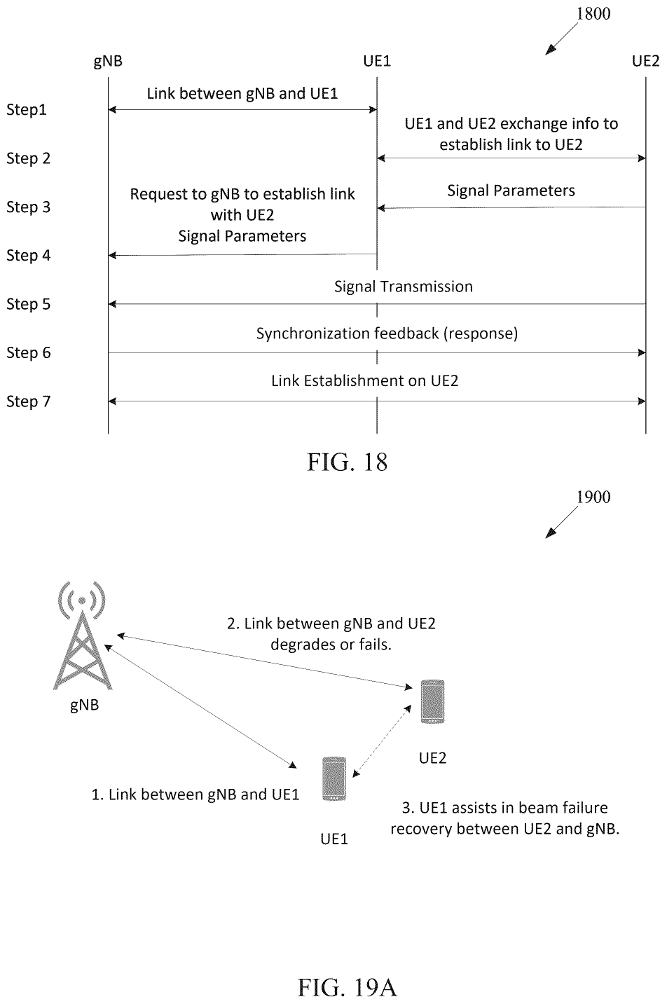

FIG. 18 illustrates a signaling flow of link establishment 1800 according to embodiments of the present disclosure. The signaling flow 1800 as may be performed by a UE (e.g., 111-116 as illustrated in FIG. 1). An embodiment of the signaling flow 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions.

The signaling flow of FIG. 18 illustrates an example where the UE1 can assist with establishing a link between the network and the UE2. In the example, as illustrated in FIG. 18, the reference signal for initial access is transmitted by the UE2. In the example illustrated in FIG. 18, the link between the UE2 and the network is established to the same gNB as the link between the UE1 and the network, however, the link between the UE1 and the network and the link between the UE2 and the network can use different gNBs or TRPs, a similar procedure is used, but it is understood that internal signaling within the network can be used to establish the link between the network and the UE2 on a gNB different from the gNB used for the UE1.

In the example of FIG. 18, a link has been established between the gNB and a first UE (e.g., UE1). The UE1 identifies a second UE (e.g., UE2), and the link is to be transferred to the UE2 or a new link established on UE2. The UE1 and the UE2 exchange information to assist in the transfer of the link to the UE2 or establishing new link on UE2. In one example of FIG. 18, a second UE (e.g., UE2) wants to establish a link with the gNB. The UE2 identifies a first UE (e.g., UE1), with a link established with the gNB. The UE1 and the UE2 exchange information to assist in establishing a new link on the UE2 with the gNB. In a one example of FIG. 18, a first UE (e.g., UE1) with a link established with the gNB, identifies a second UE (e.g., UE2) to establish a link with the gNB. The UE1 and the UE2 exchange information to assist in establishing a new link on the UE2 with the gNB. In one example, of the aforementioned examples, the gNB to which the UE2 establishes a link is the same as the gNB to which the UE1 has a link established. In one example, of the aforementioned example, the gNB to which the UE2 establishes a link is different from the gNB to which the UE1 has link established.

In step S1 of FIG. 18, the UE1 has a link established with the network. In step S2, a link is to be transferred or a new link established on the UE2, the link between the UE2 and the network can be on the same frequency (e.g., carrier frequency or BWP or CC), frequency band, or frequency range as link between the network and the UE1. In another example, the link between the UE2 and the network can be on a different frequency (e.g., carrier frequency or BWP or CC), or different frequency band or different frequency range than the link between the network and the UE1.

In one example, the information exchange is on SL interface (e.g., PC5 interface), e.g., using NR SL protocol or using LTE SL protocol. In one example, the information exchange is on a non-3GPP interface such as WiFi or Bluetooth. In one example, the UE1 sends a request to the UE2 to accept the link transfer or a new link. In one example, the UE2 sends a request to the UE1 to have the link transferred to the UE2 or a new link established on the UE2. In one example, the UE2 provides the UE1 with information to assist with link establishment on the UE2. In one example, the UE2 provides the UE1 with information to assist with the link transfer or link establishment on the UE2. In one example, the UE2 provides the UE2's positioning information to assist with the link transfer or link establishment on the UE2.

In one example, the UE2 provides the UE2's positioning information to assist with a link transfer or link establishment on the UE2. In one example, positioning information can include radio access technology (RAT)-dependent positioning information, e.g., positioning measurements. In one example, positioning information can include radio access technology RAT-independent positioning information. In one example, positioning information can include positioning measurements on the Uu interface and/or positioning measurements on the SL. In one example, positioning information includes location information, e.g., co-ordinates in a global co-ordinate system or co-ordinates in a local co-ordinate system. In one example, the UE2's synchronization source is a signal transmitted from the UE1 (e.g., S-SSB transmitted on the SL interface).

The UE2 determines a signal S to transmit to the gNB to assist with link establishment or initial access (e.g., beam identification for the link between the gNB and the UE2, can also assist with timing advance (TA) determination). In one example, S is a physical random access channel (PRACH). In one example, S is a sounding reference signal (SRS). In one example, S is a PUSCH. In one example, S is a PUSCH DMRS. In one example, S is PUCCH. In one example, S is a PUCCH DMRS. In one example, S is a low power signal received by a low power receiver on the gNB. In one example, signal S can be as illustrated in FIG. 14 (e.g., (a) or (b) as illustrated in FIG. 14).

The parameters of the signal S can include at least one of the following parameters as shown in examples.

In one example, the parameters of the signal S can include time related parameters, including, whether the signal is periodic, semi-persistent or aperiodic with one-shot transmission or N shot transmissions, time of transmission (e.g., symbol and/or slot and/or sub-frame and/or frame). Time of transmission can be an absolute time, or a relative time relative to a second signal or channel (e.g., signal B as discussed later in this disclosure). Time related parameters can also include periodicity of signal S and offset within periodicity. Time related parameters can also include number of transmission instances of signal S for each occasion of signal S. Time related parameters can also include number of transmission occasions of signal S. Time related parameters can also include duration of signal S (e.g., in number of symbols or slots), and time related parameters for each instance of signal S of a transmission occasion of signal S.

In one example, the parameters of the signal S can include frequency related parameters, including size in frequency domain (e.g., number of PRBs or number of sub-carriers or number of sub-channels), starting positioning in frequency domain (e.g., starting PRB or starting sub-carrier or starting sub-channel), location of sub-carriers with a PRB, whether a comb-structure is used and the comb size and comb offset, BWP used for signal S, carrier used for signal S. Frequency band of signal S. Frequency region of signal S. Frequency related parameters (including comb if applicable) for each instance of signal S of a transmission occasion of signal S.

In one example, the parameters of the signal S can include code related parameters, such as scrambling sequence index or preamble index, pseudo random sequence index and orthogonal cover index if applicable. Code related parameters for each instance of signal S of a transmission occasion of signal S if applicable.

Signal B can be one of the following: (i) signal transmitted from the UE1 to the UE2, e.g., in or after step 2 of FIG. 18 for link establishment on the UE2; (ii) acknowledgment or feedback to signal transmitted from the UE1 to the UE2, e.g., in or after step 2 of FIG. 18 for link establishment on the UE2; (iii) signal transmitted from the UE2 to the UE1, e.g., in or after step 2 of FIG. 18 for link establishment on the UE2; (iv) acknowledgment of feedback to signal transmitted from the UE2 to the UE1, e.g., in or after step 2 of FIG. 18 for link establishment on the UE2; (v) signal transmitted in step 3 of FIG. 18 with information about signal S; and/or (v) acknowledgement or feedback to signal transmitted in step 3 of FIG. 18 with information about signal S.

In one example, signal S can be transmitted at or after a time T from the end (or start) signal B. In one example, the slot or subframe or frame used to transmit signal S can be (or can start) at least a time T after the end (or start) of signal B. In one example, the slot or subframe or frame used to transmit signal S is the first slot or subframe or frame that starts at or after a time T from the end (or start) of signal B and optionally based on an offset and a periodicity as illustrated in FIG. 17. Wherein, the time T can be defined in the system specifications and/or configured or updated by the network (e.g., using SIB signaling and/or RRC signaling and/or MAC CE signaling and/or L1 control signaling).

FIG. 17 illustrates an example of signal S configuration, where a signal S period is configured (e.g., 8 slots) and a signal S offset within the signal S period for the S-signal slots is configured (e.g., 2 slots). In one example, each occasion of signal S can include multiple instances (e.g., a burst of intances), e.g., transmitted on different beams, as illustrated in FIG. 17. The configuration of the signal S offset and signal S period can be by SIB configuration or by RRC configuration. The signal S period and the signal S offset determine the potential (possible) signal S transmission occasions. At or after a delay T from a signal B the signal S can be transmitted. A first occasion of signal S is transmitted in the earliest (first) potential signal S occasion (as determined by the period and offset) occurring at or after a time T from signal B as illustrated in FIG. 17. In FIG. 17, signal S is transmitted in two occasions. In one example, time T is measured from the start signal B. In one example, time T is measured from the end signal B. T can be configured by RRC signaling and/or MAC CE signaling and/or L1 control signaling.

In one example, the UE2 determines the parameters of signal S. In step S3 of FIG. 18, the UE2 provides information related to the parameters of signal S, as aforementioned, to the UE1. In one example, if the UE2 does not receive the acknowledgment of feedback, the UE2 (re-)transmits the signal providing parameters of signal S. In one example, there is no signal transmitted from the UE2 to provide parameters related to signal S, for example, the parameters can be determined by pre-configuration.

In step S4 of FIG. 18, the UE1 sends a request to the gNB for link establishment on the UE2, and the UE1 provides information related to the parameters of signal S to the gNB. In one example, after the gNB receives the signal from the UE1 with the parameters of signal S, the gNB transmits an acknowledgment or feedback. In one example, the acknowledgment or feedback can be transmitted in DCI Format or MAC CE or ASN. 1 message. In one example, if the UE1 does not receive the acknowledgment or feedback, the UE1 (re-)transmits the signal providing parameters of signal S. In one example, there is no signal transmitted from the UE1 to provide parameters related to signal S, for example, the parameters can be determined by pre-configuration.

In one example, steps S3 and/or S4 are not performed and the information related to signal S is determined by an earlier configuration. In one example of steps S3 and S4, the UE1 sends a request to the gNB for link establishment on the UE2, the gNB determines the parameters for signal S and provides the parameters to the UE1, and the UE1 provides the parameters of signal S to the UE2. In one example of steps S3 and S4, the UE1 determines the parameters of signal S and provides the parameters to the UE2 and to the gNB and the UE1 sends a request to the gNB for link establishment on the UE2. In one example of steps S3 and S4, the UE1 sends a messages related to link establishment on the UE2 to the gNB. In one example of steps S3 and S4, the UE1 sends a messages related to link establishment on the UE2 to the UE2. In one example of steps S3 and S4, the UE1 sends a message(s) related to link establishment on the UE2 to the gNB and the UE2. In one example of steps S3 and S4, the UE2 sends a message(s) related to link establishment on the UE2 to the UE1. In one example of steps S3 and S4, the UE2 sends a message(s) related to link establishment on the UE2 to the UE1 and the UE1 sends a message(s) related to link establishment on the UE2 to the gNB.

In step S5 of FIG. 18, the UE2 transmits signal S, the gNB identifies a beam based on an instance of signal S to use when communicating with the UE2. In one example, transmission of signal S can continue until the UE2 receives a message or a signal from the gNB or an event deactivates signal S. In one example, transmission of signal S can be for M occasions. In one example, M is 1. In one example, M can be defined in the system specifications. In one example, M can be configured by RRC signaling and/or MAC CE signaling and/or L1 control signaling. In one example, transmission of signal S can be for M occasions or until a message or an event stops signal S. In one example, the UE1 can send a message or signal to the UE2 to stop or deactivate the transmission of signal S. In one example, the gNB can send a message or signal to UE to stop or deactivate the transmission of signal S. In one example, signal S can be SRS. In one example, signal S can be PRACH preamble (e.g., CFRA preamble).

In one example, signal S can be PUSCH. In one example signal S can be PUSCH DMRS. In one example, signal S can be PUCCH DMRS. In one example, signal S can be PUCCH. In one example, signal S can be PUCCH DMRS. In one example, signal S can be a low power signal, e.g., received by a low power receiver on the gNB. In one example, a transmission of signal S includes multiple (e.g., N) instances on different spatial domain transmission filters (beams) for beam sweeping. In one example each occasion of signal S includes N instances as aforementioned. In one example, a UE identifies an instance of signal S based on the signal quality of the instance of signal S (e.g., quality can be RSRP or RSSI or RSRQ or SINR) for the corresponding instance. e.g., instance of signal S with a quality above a threshold or an instance of signal S with the best (e.g., highest) quality. In one example, an instance of signal S is associated with a beam.

In step S6 of FIG. 18, the gNB transmits a signal or message “C” (e.g., as an acknowledgment or feedback) to the UE2 related to or including beam identified (e.g., instance of signal S gNB identified). This establish a beam pair to use between the UE2 and the gNB. In one example, the signal or message “C” is sent directly from the gNB to the UE2. In one example, the signal or message “C” is sent via the UE1, i.e., the gNB sends a first signal or message to the UE1 and in response, the UE1 sends a second signal or message (e.g., signal or message “C”) to the UE2. In one example, after receiving the signal or message “C,” the UE2 stops transmitting signal S. In one example, if signal S is a periodic signal, after receiving the signal or message “C” in step S6, the UE2 stops transmitting periodic signal S.

In one example, if signal S has M occasions, and the UE2 transmitted less than M occasions, after receiving the signal or message “C” in step S6, the UE2 can stop transmitting the remaining occasions. In one example, the gNB identifies an instance of signal S based on signal S quality (e.g., quality can be RSRP or RSSI or RSRQ or SINR), e.g., instance of signal S with a quality above a threshold or an instance of signal S with the best (e.g., highest) quality. In one example, the gNB transmits a DCI format or MAC CE or ASN.1 message including the identified instance of signal S. In one example, the gNB transmits a DCI format or MAC CE or ASN.1 message including a UE ID or RNTI for or associated with the UE2. In one example, the gNB transmits a DCI format or MAC CE or ASN.1 message including a UL grant for an UL transmission from the UE2.

In step S7 of FIG. 18, after a beam pair has been identified for communication between the gNB and the UE2, a link can be established between the gNB and the UE2. The link can be a transferred link from the UE1 or a new link established on the UE2.

In one example, a first UE (e.g., UE1) has a link established with the gNB. The UE1 provides assistance to a second UE (e.g., UE2) to establish a new link, to a third UE (e.g., UE3) to establish a new link, . . . , and to an (N+1)th UE (e.g., UE (N+1)) to establish a new link. The procedure described in the previous steps can occur in parallel, for each of the N UEs (i.e., UE2, UE3, . . . . UE (N+1)). The links between UE1, UE2, UE3, . . . , UE (N+1) and the network can be on same or different frequencies (e.g., carrier frequencies or BWPs or CCs), or same or different frequency bands or same or different frequency ranges.

In one example, in step S2, each of the N UEs, e.g., UE2, UE3, . . . . UE (N+1), exchange information with the UE1 to assist with the link establishment on the UE2, the UE3, . . . . UE (N+1) respectively. In one example, the information exchange can be initiated by the UE1. In one example, the information exchange can be initiated by the UE2, the UE3, . . . the UE (N+1) respectively.

In one example, in step 3, a signal S is transmitted by each of the N UEs (e.g., UE2, UE3, . . . . UE (N+1)) to assisted with initial access or link establishment for a corresponding UE of the N UEs. In one example, the parameters for each signal S from a UE are provided from each of the N UEs to the UE1. In one example, the parameters for each signal S from a UE are provided from the UE1 to each of the N UEs.

In one example, in step 4, the parameters of signal S from each of the N UEs (e.g., UE2, UE3, . . . . UE (N+1)) are provided from the UE1 to the network (e.g., gNB). In one example, the parameters of signal S from each of the N UEs (e.g., UE2, UE3, . . . . UE (N+1)) are provided in a single message from the UE1 to the network (e.g., gNB). In one example, the parameters of signal S from a UEi of the N UEs (e.g., UE2, UE3, . . . . UE (N+1)) are provided in a message for UEi from the UE1 to the network (e.g., gNB). In one example, the parameters of signal S for a subset of UEs of the N UEs (e.g., UE2, UE3, . . . . UE (N+1)) are provided in a message for the subset of UEs from the UE1 to the network (e.g., gNB). In one example, the parameters are pre-configured.

In one example, in step 5, each UEi of the N UEs (e.g., UE2, UE3, . . . . UE (N+1)) transmits a corresponding signal S to the network e.g., gNB (or gNBs as different gNBs can be used for initial access or link establishment for the different UEs).

In one example, in step 6, based on the reception signal S from UEi of the N UEs (UE2, UE3, . . . . UE (N+1)), at the corresponding gNB(s), the network, e.g., gNB(s) identifies an instance of reference signal S for a spatial domain filter (e.g., beam) for communicating with the network. The corresponding gNB can transmit a signal in response, to UEi as aforementioned. In one example, the signal transmitted can include or indicate the identified instance of signal S (e.g., beam) and/or or the corresponding UE. In one example, the signal transmitted is to a single UE of the N UEs. In one example, the signal transmitted is to a subset (e.g., group) of UEs of the N UEs. In one example, the signal transmitted is to all UEs of the N UEs. In one example, UEi can stop transmission of a signal S when UEi receives the corresponding signal as aforementioned. In one example, the signal transmitted by the gNB is a DCI format, e.g., in PDCCH. In one example, the signal transmitted by the gNB is a PDSCH, e.g., using MAC CE or ASN.1 message.

In NR, the PHY layer determines a beam failure detection instance when RSRP of a beam failure detection reference signal (e.g., BFD RS) is less than a threshold. The BFD RS can be a periodic CSI-RS. When the PHY layer detects a beam failure instance, an indication is sent to the MAC layer. The MAC layer starts a timer (beamFailureDetectionTimer) and increments a counter (BFI_COUNTER) by 1. If the counter reaches or exceeds a threshold (beamFailureInstanceMaxCount) before the timer expires, beam failure recovery is triggered for this BFD-RS. If the timer expired, the counter (BFI_COUNTER) is reset to zero. When beam failure recovery is triggered, the UE identifies a new beam from the candidate beam list, wherein the candidate beam list can be periodic CSI-RS or SS/PBCH Block (SSB). The UE transmits a beam failure recovery request (BFRQ) to the network, wherein the BFRQ includes an indication on the newly identified beam. The network responds with a beam failure recovery response (BFRR), and after a time from the BFRR, the UE applies the new beam, which completes the beam failure recovery procedure. For PsCell, the BFRQ is PRACH based, and BFRR is sent in the recovery search space. For SCell, the UE uses the PsCell for recovery of the SCell when the SCell fails, the UE transmits SR on PUCCH for BFR, after getting an uplink grant, the UE sends a PUSCH that includes the BFR MAC CE, the BFR MAC CE includes the index of the SCell(s) with beam failure and newly identified candidate beam. The network responds with a PDCCH with a new UL grant for the same HARQ process as the BFR MAC CE and addressed to the C-RNTI.

The present disclosure provides a group of UEs moving together, the UE can be part of a closed subscriber group, or can be configured to be part of a group. A first UE can provide assistance for beam failure recovery to a second UE. For example, assistance can be provided for beam failure detection reference signal resources, or for new beam identification reference signal resources or resources to provide a candidate RS ID to the network, or for the providing the RS ID to the network.

In one example, the quality of a link between the network and a second UE can degrade or fail, and the second UE sends a request to the first UE to assist in recovering the link between the network and second UE.

In one example, the quality of a link between the network and a second UE can degrade or fail, and the network sends a request to the first UE to assist in recovering the link between the network and second UE.

In one example, the first UE can assist in having the network transmit a beam failure detection reference signal (BFD RS) to the second UE. In one example, the first UE can assist in having the network transmit a new beam identification reference signal (NBI RS) to the second UE. In one example, the first UE can assist in identifying resources for the second UE to transmit a beam identification reference signal to the network. In one example, the first UE can receive a candidate beam reference signal ID from the second UE and provide the ID to the network.

In one example, the first UE can assist in having the second UE transmit a beam failure detection reference signal (BFD RS) to the network. In one example, the first UE can assist in having the second UE transmit a new beam identification reference signal (NBI RS) to the network UE. In one example, the first UE can assist in identifying resources for the network to transmit a beam identification reference signal to the second UE. In one example, the first UE can receive a candidate beam reference signal ID from the second UE and provide the ID to the gNB.

The present disclosure relates to a 5G/NR and/or 6G communication system.

The present disclosure provide embodiments related to design of UE assisted beam failure recovery, wherein a first UE can assist with failure recovery of a second UE.

This includes: (i) triggering transmission of reference signals for beam failure detection and new beam identification. The reference signals can be transmitted from the second UE or from network; (ii) identification or activation of resources for conveying identified beam between the network and second UE; and (iii) conveying identified beam between the network and second UE.

In some embodiments, when a beam becomes active, it applies to a spatial filter for transmission or reception.

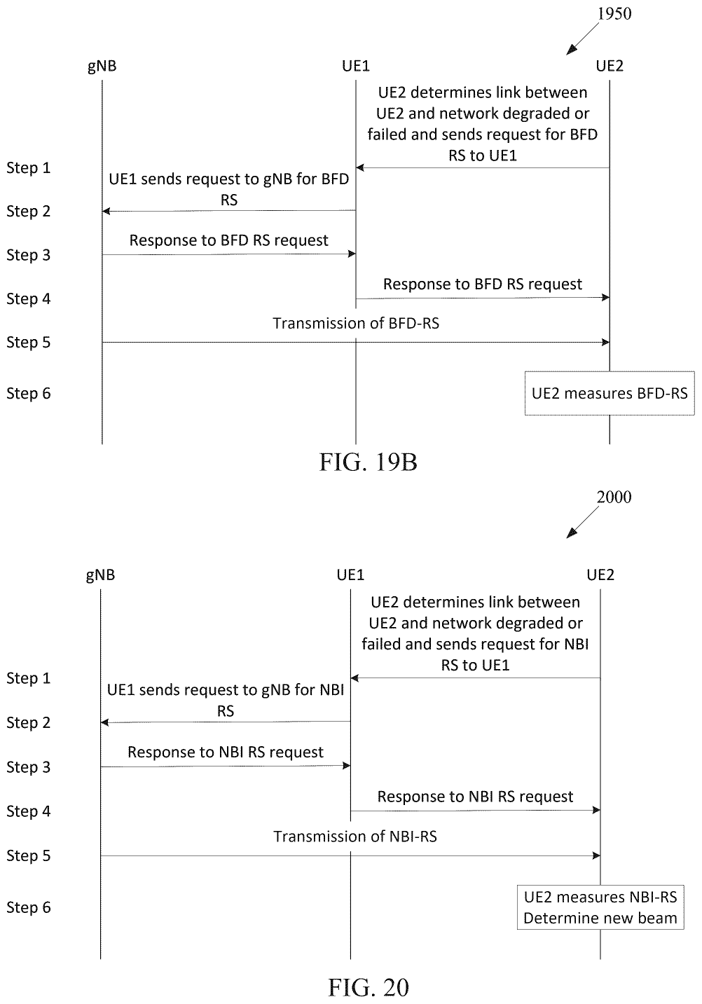

FIG. 19A illustrates another example of link establishment 1900 according to embodiments of the present disclosure. An embodiment of the link establishment 1900 shown in FIG. 19A is for illustration only.

In FIG. 19A, a first UE (e.g., UE1) has a link established with the gNB, and a second UE (e.g., UE2) has a link established with the gNB or with a different gNB. In one example, the link between the UE2 and the corresponding gNB degrades or fails. The UE1 and the UE2 exchange information and signaling related to the degraded or failed link, and the UE1 assists the UE2 and/or the network (e.g., gNB) to perform beam failure recovery for the link between the UE2 and the network. In another example, the network (e.g., gNB) provides information to the UE1 and the UE1 assists the UE2 and/or the network (e.g., gNB) to perform beam failure recovery for the link between the UE2 and the network. In another example, the network (e.g., gNB) provides information to UE1 and UE1 assists UE2 and/or the network (e.g., gNB) to perform beam failure recovery for the link between UE2 and the network. In one example, UE1 and UE2 can be part of a UE group, e.g., a closed subscriber group. In one example, the link established between UE2 and the network can be on the same frequency (e.g., carrier frequency or BWP or component carrier (CC)) or frequency band or frequency range as link between the network and UE1. In another example, the link between UE2 and the network can be on a different frequency (e.g., carrier frequency or BWP or CC), or different frequency band or different frequency range than the link between the network and UE1.

FIG. 19B illustrates a signaling flow of UE assistance of beam failure detection 1950 according to embodiments of the present disclosure. The signaling flow 1950 as may be performed by a UE (e.g., 111-116 as illustrated in FIG. 1). An embodiment of the signaling flow 1950 shown in FIG. 19B is for illustration only. One or more of the components illustrated in FIG. 19B can be implemented in a specialized circuitry configured to perform the noted functions or one or more of the components can be implemented by one or more processors executing instructions to perform the noted functions.

The signaling flow of FIG. 19B illustrates an example where a first UE (UE1) can assist second UE (UE2) with beam failure detection and recovery for a link between the network and the UE2. As illustrated in FIG. 19B, the reference signal for beam failure detection and recovery is transmitted by the gNB. In the example illustrated in FIG. 19B, the link between the UE2 and the network is to the same gNB as the link between the UE1 and the network, however, the link between the UE1 and the network and the link between the UE2 and the network can use different gNBs or TRPs, a similar procedure is used, but it is understood that internal signaling within the network can be used to establish the link between the network and the UE2 on a gNB different from the gNB used for the UE1.

As illustrated in FIG. 19B, a first link has been established between the gNB and a first UE (e.g., UE1). A second link has been established between the gNB and a second UE. In one example, the gNB of the first link and the gNB of the second link are the same. In one example, the gNB of the first link and the gNB of the second link can be different. In one example, the first link between the first UE and the network can be to more than one gNB for example in case of coherent joint transmission (CJT) or non-coherent joint transmission (NCJT). In one example, the second link between the second UE and the network can be to more than one gNB for example in case of coherent joint transmission (CJT) or non-coherent joint transmission (NCJT).

In one example, the link between the UE2 and the network (e.g., gNB) can be on the same frequency (e.g., carrier frequency or BWP or CC) or frequency band or frequency range as the link between the network and the UE1. In another example, the link between the UE2 and the network (e.g., gNB) can be on a different frequency (e.g., carrier frequency or BWP or CC), or different frequency band or different frequency range than the link between the network and the UE1.

In step 1 of FIG. 18, the second UE determines that the second link has a degraded quality or has failed. In one example, the second UE makes the aforementioned determination based on a measurement, e.g., a link quality measurement. In one example, the link quality measurement is based on BLER. In one example, the link quality measurement is based on a RSRP or RSRQ or SINR of a reference signal. In one example, the reference signal can be PDCCH DM-RS for a PDCCH from the network (e.g., gNB) to the second UE. In one example, the reference signal can be PDSCH DM-RS for a PDSCH from the network (e.g., gNB) to the second UE. In one example, the reference signal can be CSI-RS for a CSI-RS from the network (e.g., gNB) to the second UE. In one example, the reference signal can be SSB (SS/PBCH Block) for a SSB from the network (e.g., gNB) to the second UE. In one example, the reference signal can be LP-SS for a LP-SS from the network (e.g., gNB) to the second UE. In one example, the link quality is based on RSSI of a channel or signal. In one example, the channel or signal is PDCCH or PDCCH-DMRS for a PDCCH from the network (e.g., gNB) to the second UE. In one example, the channel or signal is PDSCH or PDSCH-DMRS for a PDSCH from the network (e.g., gNB) to the second UE. In one example, the channel or signal is CSI-RS for a CSI-RS from the network (e.g., gNB) to the second UE. In one example, the channel or signal is SSB for a SSB from the network (e.g., gNB) to the second UE. In one example, the channel or signal is LP-SS for a LP-SS from the network (e.g., gNB) to the second UE.

In one example, the UE2 is configured a threshold, wherein if the link quality is less than (or is less than or equal to the threshold), the second UE requests assistance from the first UE for beam failure recovery. In one example, the threshold can be configured and/or updated by higher layer signaling (e.g., SIB-based or using dedicated RRC configuration), or by MAC CE signaling or by L1 control (e.g., DCI) signaling.

In one example, the information exchange is on SL interface (e.g., PC5 interface), e.g., using NR SL protocol or using LTE SL protocol. In one example, the information exchange is on a non-3GPP interface such as WiFi or Bluetooth. In one example, the UE2 sends a request to the UE1 to assist with beam failure recovery. In one example, the UE2 sends a request to the UE1 to assist with beam failure recovery by requesting transmission of beam failure detection reference signal. In one example, the UE2 provides the UE1 with information about beam failure detection reference signal (e.g., resources or resource set(s) or configuration of such signal). In one example, the UE2 provides UE2's positioning information to assist with beam failure detection/recovery. In one example, positioning information can include radio access technology (RAT)-dependent positioning information, e.g., positioning measurements. In one example, positioning information can include radio access technology RAT-independent positioning information. In one example, positioning information can include positioning measurements on the Uu interface and/or positioning measurements on the SL. In one example, positioning information includes location information, e.g., co-ordinates in a global co-ordinate system or co-ordinates in a local co-ordinate system.

In step 2 of FIG. 18, the UE1 sends a request to the gNB for beam failure detection/recovery on the UE2, e.g., the network (the gNB of UE1 or another gNB(s)) transmit a reference signal to assist the UE2 beam failure detection/recovery. In one example, the request from the UE1 to the gNB provides information about beam failure detection reference signal (e.g., resources or resource set(s) or configuration of such signal), wherein the information can be generated by the UE1 or the information can be generated by the UE2. In one example, the request can include positioning information for the UE2, to assist the network in determining the gNB(s) and/or the spatial domain filters (beams) to use to transmit the reference signal (e.g., BFD-RS). In one example, after the gNB receives the signal from the UE1, the gNB transmits an acknowledgment or feedback. In one example, the acknowledgment or feedback can be a DCI format or MAC CE or ASN.1 message. In one example, if the UE1 does not receive the acknowledgment or feedback, the UE1 (re-)transmits the request to the gNB for beam failure detection/recovery. In one example, the feedback can be the signal transmitted in step 3.

The network determines a signal S (e.g., BFD-RS) to transmit to assist with beam failure detection/recovery. In one example, S is a Synchronization Signal/Physical Broadcast Channel (SS/PBCH) Block, referred to an SSB. In one example, S is a channel state information reference signal (CSI-RS). In one example, S is a PDSCH. In one example, S is a PDSCH DMRS. In one example, S is PDCCH. In one example, S is a PDCCH DMRS. In one example, S can be LP-SS as aforementioned. In one example, signal S can be as illustrated in FIG. 14 (e.g., (a) or (b) as illustrated in FIG. 14).

The parameters of signal S can include at least one of the following examples.

In one example, the parameters of signal S can include time related parameters, including, whether the signal is periodic, semi-persistent or aperiodic with one-shot transmission or N shot transmissions, time of transmission (e.g., symbol and/or slot and/or sub-frame and/or frame). Time of transmission can be an absolute time, or a relative time relative to a second signal or channel (e.g., signal A as discussed later in this disclosure). Time related parameters can also include periodicity of signal S and offset within periodicity. Time related parameters can also include number of transmission instances of signal S for each occasion of signal S. Time related parameters can also include number of transmission occasions of signal S. Time related parameters can also include duration of signal S (e.g., in number of symbols or slots), and time related parameters for each instance of signal S of a transmission occasion of signal S.

In one example, the parameters of signal S can include frequency related parameters, including size in frequency domain (e.g., number of PRBs or number of sub-carriers or number of sub-channels), starting positioning in frequency domain (e.g., starting PRB or starting sub-carrier or starting sub-channel), location of sub-carriers within a PRB, whether a comb-structure is used and the comb size and comb offset, BWP used for signal S, carrier used for signal S. Frequency band of signal S. Frequency region of signal S. Frequency related parameters (including comb if applicable) for each instance of signal S of a transmission occasion of signal S.

In one example, the parameters of signal S can include code related parameters, such as scrambling sequence index, pseudo random sequence index and orthogonal cover index if applicable. Code related parameters for each instance of signal S of a transmission occasion of signal S if applicable.

In one example, the parameters for signal S (e.g., BFD-RS) are determined by the second UE as aforementioned. In one example, the parameters for signal S (e.g., BFD-RS) are determined by the first UE as aforementioned. In one example, the parameters for signal S (e.g., BFD-RS) are determined by the network (e.g., gNB). In one example, the parameters for signal S (e.g., BFD-RS) are determined by the second UE and/or the first UE and/or the network (e.g., gNB).

Signal A can be one of the following: (i) signal transmitted from the UE1 to the gNB in step 2 of FIG. 19B for beam failure detection/recovery for the UE2; (ii) acknowledgment or feedback to signal transmitted from the UE1 to the gNB in step 2 of FIG. 19B for beam failure detection/recovery for the UE2; (iii) signal transmitted in step 3 of FIG. 19B with information about signal S; and/or (iv) acknowledgement or feedback to signal transmitted in step 3 of FIG. 19B with information about signal S.

In one example, a gNB transmits a BFD-RS continuously (e.g., periodically with periodic occasions), wherein the reference signal is as aforementioned. In one example, a gNB transmits BFD-RS on demand.

In step 3 of FIG. 19B, the gNB provides information related to the parameters of signal S (e.g., BFD-RS), as aforementioned, to the UE1. In one example, after the UE1 receives the signal from the gNB with the parameters of signal S, the UE1 transmits an acknowledgment or feedback. In one example, the acknowledgment or feedback can be transmitted in a PUCCH or PUSCH. In one example, the acknowledgment or feedback can be a HARQ-ACK. In one example, the acknowledgment or feedback can be a MAC CE or ASN.1 message on PUSCH. In one example, if the gNB does not receive the acknowledgment or feedback, the gNB (re-)transmits the signal providing parameters related to signal S. In one example, there is no signal transmitted from the gNB to provide parameters related to signal S, for example, the parameters can be determined by pre-configuration or determined by the first UE or the second UE as aforementioned.

In step 4 of FIG. 19B, the first UE provides information related to the parameters of signal S (e.g., BFD-RS) to second UE. In one example, there is no signal transmitted from the first UE to the second UE to provide parameters related to signal S, for example, the parameters can be determined by pre-configuration or determined by the second UE as aforementioned. In one example, steps 3 and/or 4 are not performed and the information related to signal S is determined by an earlier configuration. The UE1 provides information on signal S to the UE2 on a wireless interface between the UE1 and the UE2. In one example, the wireless interface is a SL interface (e.g., PC5 interface), e.g., using NR SL protocol or using LTE SL protocol. In one example, the wireless interface is a non-3GPP interface such as WiFi or Bluetooth.

In step 5 of FIG. 19B, the gNB transmits signal S (e.g., BFD-RS). In one example, transmission of signal S can continue until the gNB receives a message or a signal from the second UE or the first UE or an event to deactivate signal S. In one example, transmission of signal S can be for M occasions. In one example, M is 1. In one example, M can be defined in the system specifications. In one example, M can be configured by RRC signaling and/or MAC CE signaling and/or L1 control signaling. In one example, transmission of signal S can be for M occasions or until a message or an event stops signal S. In one example, the first UE can send a message or signal to the gNB to stop or deactivate the transmission of signal S. In one example, the second UE can send a message or signal to the gNB to stop or deactivate the transmission of signal S. In one example, an instance of signal S is associated with a beam.

In step 6 of FIG. 19B, the second UE measures signal S (e.g., BFD-RS). In one example, the second UE can determine if there is a beam failure based on the measurement of signal S. In one example, the second UE measures a quality signal S. In one example, the quality measurement is based on a RSRP or RSRQ or SINR of a signal S. In one example, the quality is based on RSSI signal S. In one example, the UE2 is configured a threshold, wherein if the quality of signal S is less than (or is less than or equal to the threshold), a beam failure detection or beam failure detection instance is declared. In one example, the threshold can be configured and/or updated by higher layer signaling (e.g., SIB-based or using dedicated RRC configuration), or by MAC CE signaling or by L1 control (e.g., DCI) signaling.

In one example, a beam failure detection is declared when a number of beam failure detection instances, K, occurs within a certain time window T. In one example, the K and/or T can be configured and/or updated by higher layer signaling (e.g., SIB-based or using dedicated RRC configuration), or by MAC CE signaling or by L1 control (e.g., DCI) signaling. In one example, beam failure detection is determined by the higher RAN layers (e.g., MAC layer). In one example, beam failure detection is determined by the lower RAN layers (e.g., physical layer). In one example, beam failure instance is determined by the lower RAN layers (e.g., physical layer).

In one example, a beam failure instance is determined based on the second link or BFD-RS and a threshold, as aforementioned, has a degraded quality or has failed. In one example, the second UE makes the aforementioned determination based on a measurement, e.g., a link quality measurement. In one example, the link quality measurement is based on BLER. In one example, the link quality measurement is based on a RSRP or RSRQ or SINR of a reference signal. In one example, the reference signal can be PDCCH DM-RS for a PDCCH from the network (e.g., gNB) to the second UE. In one example, the reference signal can be PDSCH DM-RS for a PDSCH from the network (e.g., gNB) to the second UE. In one example, the reference signal can be CSI-RS for a CSI-RS from the network (e.g., gNB) to the second UE. In one example, the reference signal can be SSB (SS/PBCH Block) for a SSB from the network (e.g., gNB) to the second UE. In one example, the reference signal can be LP-SS for a LP-SS from the network (e.g., gNB) to the second UE.

In one example, the reference signal can be BFD-RS from the network (e.g., gNB) to the second UE. In one example, the link quality is based on RSSI of a channel or signal. In one example, the channel or signal is PDCCH or PDCCH-DMRS for a PDCCH from the network (e.g., gNB) to the second UE. In one example, the channel or signal is PDSCH or PDSCH-DMRS for a PDSCH from the network (e.g., gNB) to the second UE. In one example, the channel or signal is CSI-RS for a CSI-RS from the network (e.g., gNB) to the second UE. In one example, the channel or signal is SSB for a SSB from the network (e.g., gNB) to the second UE. In one example, the channel or signal is LP-SS for a LP-SS from the network (e.g., gNB) to the second UE. In one example, the reference signal can be BFD-RS from the network (e.g., gNB) to the second UE.

In one example, the beam failure detection or beam failure detection instance is determined by the second UE.

FIG. 20 illustrates another signaling flow 2000 of UE assistance of beam failure recovery according to embodiments of the present disclosure. The signaling flow 2000 as may be performed by a UE (e.g., 111-116 as illustrated in FIG. 1). An embodiment of the signaling flow 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions.

The signaling flow of FIG. 20 illustrates an example where a first UE (UE1) can assist a second UE (UE2) with beam failure recovery for a link between the network and the UE2. As illustrated in FIG. 20, the reference signal for beam failure recovery is transmitted by the gNB, e.g., set of reference signals for beam failure recovery. As illustrated in FIG. 20, the link between the UE2 and the network is to the same gNB as the link between the UE1 and the network, however, the link between the UE1 and the network and the link between the UE2 and the network can use different gNBs or TRPs, a similar procedure is used, but it is understood that internal signaling within the network can be used to establish the link between the network and the UE2 on a gNB different from the gNB used for the UE1. In one example, the recovered link for the UE2 can be to a different gNB than the gNB used for the original link between the network and the UE2.

As illustrated in FIG. 20, a first link has been established between the gNB and a first UE (e.g., UE1). A second link has been established between the gNB and a second UE. In one example, the gNB of the first link and the gNB of the second link are the same. In one example, the gNB of the first link and the gNB of the second link can be different. In one example, the first link between the first UE and the network can be to more than one gNB as aforementioned. In one example, the second link between the second UE and the network can be to more than one gNB as aforementioned. In one example, the recovered link for the UE2 is to the same gNB as original link between the UE2 and the network. In one example, the recovered link for the UE2 can be to a different gNB than the original link between the UE2 and the network.

In one example, the link between the UE2 and the network (e.g., gNB) can be on the same frequency (e.g., carrier frequency or BWP or CC) or frequency band or frequency range as the link between the network and the UE1. In another example, the link between the UE2 and the network (e.g., gNB) can be on a different frequency (e.g., carrier frequency or BWP or CC), or different frequency band or different frequency range than the link between the network and the UE1.

In step 1 of FIG. 20, the second UE determines beam failure as aforementioned. In one example, the information exchange about beam failure is on SL interface (e.g., PC5 interface), e.g., using NR SL protocol or using LTE SL protocol. In one example, the information exchange is on a non-3GPP interface such as WiFi or Bluetooth. In one example, the UE2 sends a request to the UE1 to assist with beam failure recovery. In one example, the UE2 sends a request to the UE1 to assist with beam failure recovery by requesting transmission of a new beam identification reference signal (e.g., NBI-RS). In one example, the UE2 provides the UE1 with information about NBI-RS (e.g., resources or resource set(s) or configuration of such signal).

In one example, the UE2 provides UE2's positioning information to assist with beam failure detection/recovery. In one example, positioning information can include radio access technology (RAT)-dependent positioning information, e.g., positioning measurements. In one example, positioning information can include radio access technology RAT-independent positioning information. In one example, positioning information can include positioning measurements on the Uu interface and/or positioning measurements on the SL. In one example, positioning information includes location information, e.g., co-ordinates in a global co-ordinate system or co-ordinates in a local co-ordinate system.

In step 2 of FIG. 20, the UE1 sends a request to the gNB for beam failure recovery on the UE2, e.g., the network (the gNB of UE1 or another gNB(s)) transmit a reference signal to assist the UE2 with new beam identification. In one example, the request from the UE1 to the gNB provides information about new beam identification reference signal (e.g., NBI-RS) (e.g., resources or resource set(s) or configuration of such signal), wherein the information can be generated by the UE1 or the information can be generated by the UE2. In one example, the request can include positioning information for the UE2, to assist the network in determining the gNB(s) and/or the spatial domain filters (beams) to use to transmit the reference signal (e.g., NBI-RS). In one example, after the gNB receives the signal from the UE1, the gNB transmits an acknowledgment or feedback. In one example, the acknowledgment or feedback can be a DCI format or MAC CE or ASN.1 message. In one example, if the UE1 does not receive the acknowledgment or feedback, the UE1 (re-)transmits the request to the gNB for new beam identification. In one example, the feedback can be the signal transmitted in step 3.

The network determines a signal S (e.g., NBI-RS) to transmit to assist with new beam identification. In one example, signal S are reference signals or a set of reference signals for beam failure recovery or new beam identification RS (NBI-RS). In one example, S is a synchronization signal/physical broadcast channel (SS/PBCH) Block, referred to an SSB. In one example, S is a channel state information reference signal (CSI-RS). In one example, S is a PDSCH. In one example, S is a PDSCH DMRS. In one example, S is PDCCH. In one example, S is a PDCCH DMRS. In one example, S can be LP-SS as aforementioned. In one example, signal S can be as illustrated in FIG. 14 (e.g., (a) or (b) as illustrated in FIG. 14).

The parameters of signal S can include at least one of the following examples.

In one example, the parameters of signal S can include time related parameters, including, whether the signal is periodic, semi-persistent, or aperiodic with one-shot transmission or N shot transmissions, time of transmission (e.g., symbol and/or slot and/or sub-frame and/or frame). Time of transmission can be an absolute time, or a relative time relative to a second signal or channel (e.g., signal A as discussed later in this disclosure). Time related parameters can also include periodicity of signal S and offset within periodicity. Time related parameters can also include number of transmission instances of signal S for each occasion of signal S. Time related parameters can also include number of transmission occasions of signal S. Time related parameters can also include duration of signal S (e.g., in number of symbols or slots), and time related parameters for each instance of signal S of a transmission occasion of signal S.

In one example, the parameters of signal S can include frequency related parameters, including size in frequency domain (e.g., number of PRBs or number of sub-carriers or number of sub-channels), starting positioning in frequency domain (e.g., starting PRB or starting sub-carrier or starting sub-channel), location of sub-carriers within a PRB, whether a comb-structure is used and the comb size and comb offset, BWP used for signal S, carrier used for signal S. Frequency band of signal S. Frequency region of signal S. Frequency related parameters (including comb if applicable) for each instance of signal S of a transmission occasion of signal S.

In one example, the parameters of signal S can include code related parameters, such as scrambling sequence index, pseudo random sequence index and orthogonal cover index if applicable. Code related parameters for each instance of signal S of a transmission occasion of signal S if applicable.

In one example, the parameters for signal S (e.g., NBI-RS) are determined by the second UE as aforementioned. In one example, the parameters for signal S (e.g., NBI-RS) are determined by the first UE as aforementioned. In one example, the parameters for signal S (e.g., NBI-RS) are determined by the network (e.g., gNB). In one example, the parameters for signal S (e.g., NBI-RS) are determined by the second UE and/or the first UE and/or the network (e.g., gNB).

Signal A can be one of the following: (i) signal transmitted from the UE1 to the gNB in step 2 of FIG. 20 for new beam identification for the UE2; (ii) acknowledgment or feedback to signal transmitted from the UE1 to the gNB in step 2 of FIG. 20 for new beam identification for the UE2; (iii) signal transmitted in step 3 of FIG. 20 with information about signal S; and/or (iv) acknowledgement or feedback to signal transmitted in step 3 of FIG. 20 with information about signal S.

In one example, signal S is as aforementioned in FIG. 17.

In one example, a gNB transmits an NBI-RS continuously (e.g., periodically with periodic occasions), wherein the reference signal is as aforementioned. In one example, a gNB transmits NBI-RS on demand.

In step 3 of FIG. 20, the gNB provides information related to the parameters of signal S (e.g., NBI-RS), as aforementioned, to the UE1. In one example, the gNB provides a configuration of reference signals or a set of reference signals for beam failure recovery for NBI-RS. In one example, after the UE1 receives the signal from the gNB with the parameters of signal S, the UE1 transmits an acknowledgment or feedback. In one example, the acknowledgment or feedback can be transmitted in a PUCCH or PUSCH. In one example, the acknowledgment or feedback can be a HARQ-ACK. In one example, the acknowledgment or feedback can be a MAC CE or ASN.1 message on PUSCH. In one example, if the gNB does not receive the acknowledgment or feedback, the gNB (re-)transmits the signal providing parameters related to signal S. In one example, there is no signal transmitted from the gNB to provide parameters related to signal S, for example, the parameters can be determined by pre-configuration or determined by the first UE or the second UE as aforementioned.

In step 4 of FIG. 20, the first UE provides information related to the parameters of signal S (e.g., NBI-RS) to second UE. In one example, the first UE provides to second UE a configuration of reference signals or a set of reference signals for beam failure recovery for NBI-RS, e.g., configuration received from gNB in step 3. In one example, there is no signal transmitted from the first UE to the second UE to provide parameters related to signal S, for example, the parameters can be determined by pre-configuration or determined by the second UE as aforementioned. In one example, steps 3 and/or 4 are not performed and the information related to signal S is determined by an earlier configuration. The UE1 provides information on signal S to the UE2 on a wireless interface between the UE1 and the UE2. In one example, the wireless interface is a SL interface (e.g., PC5 interface), e.g., using NR SL protocol or using LTE SL protocol. In one example, the wireless interface is a non-3GPP interface such as WiFi or Bluetooth.

In step 5 of FIG. 20, the gNB transmits signal S (e.g., NBI-RS). In one example, transmission of signal S can continue until the gNB receives a message or a signal from the second UE or the first UE or an event to deactivate signal S. In one example, transmission of signal S can be for M occasions. In one example, M is 1. In one example, M can be defined in the system specifications. In one example, M can be configured by RRC signaling and/or MAC CE signaling and/or L1 control signaling. In one example, transmission of signal S can be for M occasions or until a message or an event stops signal S. In one example, the first UE can send a message or signal to the gNB to stop or deactivate the transmission of signal S. In one example, the second UE can send a message or signal to the gNB to stop or deactivate the transmission of signal S. In one example, an instance of signal S is associated with a beam.

In step 6 of FIG. 20, the second UE measures signal S (e.g., NBI-RS). In one example, based on the measurement of signal S, the UE2 identifies a new beam for communication with the network. In one example, the second UE identifies a reference signal from the reference signals or from the set of reference signals for beam failure recovery for NBI-RS provided by gNB via first UE. In one example each occasion of signal S includes N instances as aforementioned. In one example, the UE2 identifies an instance of signal S based on the signal quality of the instance of S (e.g., quality can be RSRP or RSSI or RSRQ or SINR) for the corresponding instance. e.g., instance of signal S with a quality above a threshold or an instance of signal S with the best (e.g., highest) quality. In one example, an instance of signal S is associated with a beam. In one example, the new beam identified is associated with the same gNB that the UE2 used to communicate with the network. In one example, the new beam identified can be associated with a different gNB than that the UE2 used to communicate with the network. In one example, the new beam identified is associated with the same gNB that the UE1 uses to communicate with the network. In one example, the new beam identified can be associated with a different gNB than that the UE1 uses to communicate with the network.

In one example, the new beam is identified based on an instance of signal S (e.g., NBI-RS) determined as aforementioned. In one example, a new beam is associated with an instance (e.g., ID) of signal S. In one example, the UE2 indicates an instance (e.g., ID) of signal S for the new beam.

In one example, the UE2 indicates the new beam (or reference signal from the reference signals, e.g., S, or from the set of reference signals for beam failure recovery) to the network. In one example, the UE2 indicates the new beam directly to the network as explained later in this disclosure. In one example, the UE2 indicates the new beam to the network through the UE1 as explained later in this disclosure.

In one example, the UE2 uses UL channel or signal to the network (e.g., gNB) to indicate the newly identified beam (e.g., instance of (e.g., ID) of signal S). In one example, the UL channel is PUSCH. In one example, the UL channel is PUCCH. In one example, the UL channel is PRACH. In one example, the UL channel is PRACH using a contention free random access (CFRA) or dedicated preamble. In one example, the UL channel is PRACH using a contention based random access (CBRA) or common preamble. In one example, the UL signal is sounding reference signal (SRS). In one example, the UL channel or signal is a wake-up signal (WUS). In one example, the UL channel or signal is a channel or signal received by a low power receiver. In one example, the UL transmission with the new beam indication is UE-initiated (e.g., initiated by UE2).

In one example, the resources for the UL transmission conveying the beam indication is determined by the network (e.g., gNB). In one example, the resources for the UL transmission conveying the beam indication is determined by the network (e.g., gNB) and conveyed to the UE2 via step 3 and step 4 of FIG. 20, or by system information. In one example, the resources for the UL transmission conveying the beam indication is determined by the UE1. In one example, the resources for the UL transmission conveying the beam indication is determined by the UE1 and conveyed to the network (e.g., gNB) via step 2 of FIG. 20. In one example, the resources for the UL transmission conveying the beam indication is determined by the UE1 and conveyed to the UE2 via step 4 of FIG. 20. In one example, the resources for the UL transmission conveying the beam indication is determined by the UE2. In one example, the resources for the UL transmission conveying the beam indication is determined by the UE2 and conveyed to the network (e.g., gNB) via step 1 and step 2 of FIG. 20.

In one example, after the network (e.g., gNB) receives a new beam indication from the UE2, the network responds with a DL channel or signal confirming the reception of the new beam indication. In one example, DL channel confirming the reception of the new beam indication is a PDCCH or DCI format or MAC CE or ASN.1 message. In one example, DL channel confirming the reception of the new beam indication is a PDSCH. In one example, DL channel confirming the reception of the new beam indication is a random access response (RAR). In one example, DL signal confirming the reception of the new beam indication is a CSI-RS. In one example, DL channel or signal confirming the reception of the new beam indication is a wake-up signal (WUS). In one example, the DL channel or signal is a channel or signal received by a low power receiver.

In one example, the resources for the DL transmission is determined by the network (e.g., gNB). In one example, the resources for the DL transmission is determined by the network (e.g., gNB) and conveyed to the UE2 via step 3 and step 4 of FIG. 20, or by system information. In one example, the resources for the DL transmission is determined by the UE1. In one example, the resources for the DL transmission is determined by the UE1 and conveyed to the network (e.g., gNB) via step 2 of FIG. 20. In one example, the resources for the DL transmission is determined by the UE1 and conveyed to the UE2 via step 4 of FIG. 20. In one example, the resources for the DL transmission is determined by the UE2. In one example, the resources for the DL transmission is determined by the UE2 and conveyed to the network (e.g., gNB) via step 1 and step 2 of FIG. 20. In one example, the resources for the DL transmission is determined based on the resources for UL transmission conveying the beam indication, for example based on a configured mapping between the DL and UL resources used for the DL and UL transmissions.

In one example, DL transmission is transmitted using the new beam identified. In one example, the new beam for communication between the UE2 and the network (e.g., gNB) is activated starting from a time T from DL or UL transmission (start or end of DL or UL transmission). In one example T is specified in the system specification and/or configured or updated SIB signaling and/or RRC signaling and/or MAC CE signaling and/or L1 control (e.g., DCI) signaling.

In one example, after the network (e.g., gNB) receive a new beam indication from the UE2, the network responds with a DL channel or signal confirming the reception of the new beam indication via the UE1.

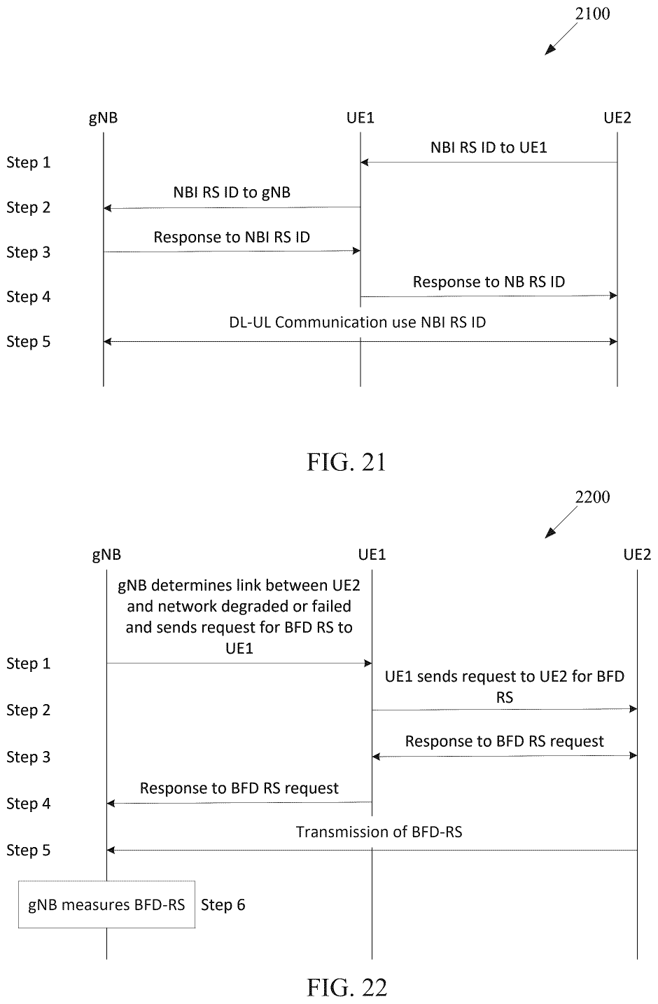

FIG. 21 illustrates yet another signaling flow 2100 of UE assistance of beam failure recovery according to embodiments of the present disclosure. The signaling flow 2100 as may be performed by a UE (e.g., 111-116 as illustrated in FIG. 1). An embodiment of the signaling flow 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions.

The signaling flow of FIG. 21 illustrates an example where a first UE (UE1) can assist second UE (UE2) with beam failure recovery for a link between the network and the UE2. In the example illustrated in FIG. 21, the link between the UE2 and the network is to the same gNB as the link between the UE1 and the network, however, the link between the UE1 and the network and the link between the UE2 and the network can use different gNBs or TRPs, a similar procedure is used, but it is understood that internal signaling within the network can be used to establish the link between the network and the UE2 on a gNB different from the gNB used for the UE1.

In one example as illustrated in FIG. 21 a first link has been established between the gNB and a first UE (e.g., UE1). A second link has been established between the gNB and a second UE. In one example, the gNB of the first link and the gNB of the second link are the same. In one example, the gNB of the first link and the gNB of the second link can be different. In one example, the first link between the first UE and the network can be to more than one gNB as aforementioned. In one example, the second link between the second UE and the network can be to more than one gNB as aforementioned.

In one example, the link between the UE2 and the network (e.g., gNB) can be on the same frequency (e.g., carrier frequency or BWP or CC) or frequency band or frequency range as the link between the network and the UE1. In another example, the link between the UE2 and the network (e.g., gNB) can be on a different frequency (e.g., carrier frequency or BWP or CC), or different frequency band or different frequency range than the link between the network and the UE1.

In step 1 of FIG. 21, the second UE (UE2) determines a new beam (e.g., instance of signal S discussed in conjunction with FIG. 20), or reference signal from the reference signals, e.g., S, or from the set of reference signals for beam failure recovery, as aforementioned. The UE2 conveys the new beam (or reference signal from the reference signals, e.g., S, or for the set of reference signals for beam failure recovery) to the network via the UE1. In step 1 of FIG. 21, the UE2 sends the new beam indication (or reference signal from the reference signals, e.g., S, or from the set of reference signals for beam failure recovery) to the UE1. In one example, the information is transmitted on SL interface (e.g., PC5 interface), e.g., using NR SL protocol or using LTE SL protocol. In one example, the information is transmitted on a non-3GPP interface such as WiFi or Bluetooth. In one example, the UE2 sends a new beam indication (e.g., instance of signal S discussed in conjunction with FIG. 20) to the UE1.

In step 2 of FIG. 21, the UE1 sends the new beam indication (or reference signal from the reference signals, e.g., S, or from the set of reference signals for beam failure recovery) to the gNB. In one example, after the gNB receives the signal from the UE1, the gNB transmits an acknowledgment or feedback. In one example, the acknowledgment or feedback can be a DCI format or MAC CE or ANS.1 message. In one example, if the UE1 does not receive the acknowledgment or feedback, the UE1 (re-)transmits the information to the gNB. In one example the feedback can be the signal transmitted in step 3.

In step 3 of FIG. 21, the gNB provides a response to the signal transmitted in step 2. In one example, signal in step 3 can include a time when the new beam becomes active. In one example, the time is a relative time (for example relative to the signal transmitted in step 3). In one example, the time is an absolute time. In one example, after the UE1 receives the signal from the gNB, the UE1 transmits an acknowledgment or feedback. In one example, the acknowledgment or feedback can be transmitted in a PUCCH or PUSCH. In one example, the acknowledgment or feedback can be a HARQ-ACK. In one example, the acknowledgment or feedback can be a MAC CE or ASN.1 message on PUSCH. In one example, if the gNB does not receive the acknowledgment or feedback, the gNB (re-)transmits the signal. In one example, there is no signal transmitted from gNB the new beam comes active at a pre-determined time.

In step 4 of FIG. 21, the UE1 provides a response back to the UE2. In one example, signal in step 4 can include a time when the new beam becomes active. In one example, the time is a relative time (for example relative to the signal transmitted in step 4). In one example, the time is an absolute time. In one example, steps 3 and/or 4 are not performed, the new beam comes active at a pre-determined time. The UE1 provides information to the UE2 on a wireless interface between the UE1 and the UE2. In one example, the wireless interface is a SL interface (e.g., PC5 interface), e.g., using NR SL protocol or using LTE SL protocol. In one example, the wireless interface is a non-3GPP interface such as WiFi or Bluetooth.

In step 5 of FIG. 21, at a time determined by pre-configuration or conveyed in the signal in step 2 or step 3 or step 4, the UE2 and the network (e.g., gNB) communicate on the new beam.

FIG. 22 illustrates yet another signaling flow 2200 of UE assistance of beam failure detection according to embodiments of the present disclosure. The signaling flow 2200 as may be performed by a UE (e.g., 111-116 as illustrated in FIG. 1). An embodiment of the signaling flow 2200 shown in FIG. 22 is for illustration only. One or more of the components illustrated in FIG. 22 can be implemented in specialized circuitry configured to perform the noted functions or one or more of the components can be implemented by one or more processors executing instructions to perform the noted functions.

The signaling flow of FIG. 22 illustrates an example where a first UE (UE1) can assist a second UE (UE2) with beam failure detection and recovery for a link between the network and the UE2. In the example of FIG. 22, the reference signal for beam failure detection and recovery is transmitted by the UE2. In the example illustrated in FIG. 22, the link between the UE2 and the network is to the same gNB as the link between the UE1 and the network, however, the link between the UE1 and the network and the link between the UE2 and the network can use different gNBs or TRPs, a similar procedure is used, but it is understood that internal signaling within the network can be used to establish the link between the network and the UE2 on a gNB different from the gNB used for the UE1.

As illustrated in FIG. 22, a first link has been established between the gNB and a first UE (e.g., UE1). A second link has been established between the gNB and a second UE. In one example, the gNB of the first link and the gNB of the second link are the same. In one example, the gNB of the first link and the gNB of the second link can be different. In one example, the first link between the first UE and the network can be to more than one gNB as aforementioned. In one example, the second link between the second UE and the network can be to more than one gNB as aforementioned.

In one example, the link between the UE2 and the network (e.g., gNB) can be on the same frequency (e.g., carrier frequency or BWP or CC), a frequency band, or a frequency range as the link between the network and the UE1. In another example, the link between the UE2 and the network (e.g., gNB) can be on a different frequency (e.g., carrier frequency or BWP or CC), or different frequency band or different frequency range than the link between the network and the UE1.

In step 1 of FIG. 22, the network (e.g., gNB) determines that the second link has a degraded quality or has failed. In one example, the network (e.g., gNB) makes the aforementioned determination based on a measurement, e.g., a link quality measurement. In one example, the link quality measurement is based on BLER. In one example, the link quality measurement is based on a RSRP or RSRQ or SINR of a reference signal. In one example, the reference signal can be PUCCH DM-RS for a PUCCH from the UE2 to the network (e.g., gNB). In one example, the reference signal can be PUSCH DM-RS for a PUSCH from the UE2 to the network (e.g., gNB). In one example, the reference signal can be SRS for an SRS from the UE2 to the network (e.g., gNB). In one example, the reference signal can be a low-power signal from the UE2 to the network (e.g., gNB) received by a low power receiver.

In one example, the reference signal can be PRACH for a PRACH from the UE2 to the network (e.g., gNB). In one example, the link quality is based on RSSI of a channel or signal. In one example, the channel or signal is PUCCH or PUCCH-DMRS for a PUCCH from the UE2 to the network (e.g., gNB). In one example, the channel or signal is PUSCH or PUSCH-DMRS for a PUSCH from the UE2 to the network (e.g., gNB). In one example, the channel or signal is SRS for an SRS from the UE2 to the network (e.g., gNB). In one example, the channel or signal is a low-power signal from the UE2 to the network (e.g., gNB) received by a low power receiver. In one example, the channel or signal is PRACH for a PRACH from the UE2 to the network (e.g., gNB).

In one example, the network (e.g., gNB) is configured a threshold, wherein if the link quality is less than (or is less than or equal to the threshold), the network (e.g., gNB) requests assistance from the first UE for beam failure recovery. In one example, the threshold can be configured and/or updated by higher layer signaling (e.g., SIB-based or using dedicated RRC configuration), or by MAC CE signaling or by L1 control (e.g., DCI) signaling.

In one example, the signal in step 1 is transmitted on PDCCH (e.g., DCI Format) or in PDSCH (e.g., MAC CE or DL-SCH or ASN. 1 message). In one example, after the UE1 receives the signal from the gNB, the UE1 transmits an acknowledgment or feedback. In one example, the acknowledgment or feedback can be transmitted in a PUCCH or PUSCH. In one example, the acknowledgment or feedback can be a HARQ-ACK. In one example, the acknowledgment or feedback can be a MAC CE or ASN. 1 message on PUSCH. In one example, if the gNB does not receive the acknowledgment or feedback, the gNB (re-)transmits the signal of step 1.

In step 2 of FIG. 22, the UE1 sends a request to the UE2 for beam failure detection/recovery on a UE2 link, e.g., the UE2 transmits a reference signal to assist the gNB to perform beam failure detection/recovery for the link with the UE2. In one example, the request from the UE1 to the UE2 provides information about beam failure detection reference signal (e.g., resources or resource set(s) or configuration of such signal), wherein the information can be generated by the UE1 or the information can be generated by the gNB. In one example, the request can include positioning information for the gNB, to assist the UE2 in determining the spatial domain filters (beams) to use to transmit the reference signal (e.g., BFD-RS).

In one example, the information exchange is on SL interface (e.g., PC5 interface), e.g., using NR SL protocol or using LTE SL protocol. In one example, the information exchange is on a non-3GPP interface such as WiFi or Bluetooth. In one example, the UE1 sends a request to the UE2 to assist with beam failure recovery. In one example, the UE1 sends a request to the UE2 to assist with beam failure recovery by requesting transmission of beam failure detection reference signal. In one example, the UE1 provides the UE2 with information about beam failure detection reference signal (e.g., resources or resource set(s) or configuration of such signal).

The UE2 determines a signal S (e.g., BFD-RS) to transmit to assist with beam failure detection/recovery. In one example, S is a physical random access channel (PRACH). In one example, S is a sounding reference signal (SRS). In one example, S is a PUSCH. In one example, S is a PUSCH DMRS. In one example, S is PUCCH. In one example, S is a PUCCH DMRS. In one example, S is a low power signal received by a low power receiver on the gNB. In one example, signal S can be as illustrated in FIG. 14 (e.g., (a) or (b) as illustrated in FIG. 14).

The parameters of signal S can include at least one of the following examples.

In one example, the parameters of signal S can include time related parameters, including, whether the signal is periodic, semi-persistent or aperiodic with one-shot transmission or N shot transmissions, time of transmission (e.g., symbol and/or slot and/or sub-frame and/or frame). Time of transmission can be an absolute time, or a relative time relative to a second signal or channel (e.g., signal A as discussed later in this disclosure). Time related parameters can also include periodicity of signal S and offset within periodicity. Time related parameters can also include number of transmission instances of signal S for each occasion of signal S. Time related parameters can also include number of transmission occasions of signal S. Time related parameters can also include duration of signal S (e.g., in number of symbols or slots), and time related parameters for each instance of signal S of a transmission occasion of signal S.

In one example, the parameters of signal S can include frequency related parameters, including size in frequency domain (e.g., number of PRBs or number of sub-carriers or number of sub-channels), starting positioning in frequency domain (e.g., starting PRB or starting sub-carrier or starting sub-channel), location of sub-carriers within a PRB, whether a comb-structure is used and the comb size and comb offset, BWP used for signal S, carrier used for signal S. Frequency band of signal S. Frequency region of signal S. Frequency related parameters (including comb if applicable) for each instance of signal S of a transmission occasion of signal S.

In one example, the parameters of signal S can include code related parameters, such as scrambling sequence index, pseudo random sequence index and orthogonal cover index if applicable. Code related parameters for each instance of signal S of a transmission occasion of signal S if applicable.

In one example, the parameters for signal S (e.g., BFD-RS) are determined by the second UE as aforementioned. In one example, the parameters for signal S (e.g., BFD-RS) are determined by the first UE as aforementioned. In one example, the parameters for signal S (e.g., BFD-RS) are determined by the network (e.g., gNB). In one example, the parameters for signal S (e.g., BFD-RS) are determined by the second UE and/or the first UE and/or the network (e.g., gNB).

Signal A can be one of the following: (i) signal transmitted from the UE1 to the UE2 in step 2 of FIG. 22 for beam failure detection/recovery for the UE2; (ii) acknowledgment or feedback to signal transmitted from the UE1 to the UE2 in step 2 of FIG. 22 for beam failure detection/recovery for the UE2; (iii) signal transmitted in step 3 of FIG. 22 with information about signal S; and/or (iv) acknowledgement or feedback to signal transmitted in step 3 of FIG. 22 with information about signal S.

In one example, signal S is as aforementioned in FIG. 17.

In one example, a UE2 transmits a BFD-RS continuously (e.g., periodically with periodic occasions), wherein the reference signal is as aforementioned. In one example, a UE2 transmits BFD-RS on demand.

In step 3 of FIG. 22, the UE2 provides information related to the parameters of signal S (e.g., BFD-RS), as aforementioned, to the UE1. The UE1 provides information on signal S to the UE2 on a wireless interface between the UE1 and the UE2. In one example, the wireless interface is a SL interface (e.g., PC5 interface), e.g., using NR SL protocol or using LTE SL protocol. In one example, the wireless interface is a non-3GPP interface such as WiFi or Bluetooth.

In one example, there is no signal transmitted from the UE2 to provide parameters related to signal S, for example, the parameters can be determined by pre-configuration or determined by the first UE or the network (e.g., gNB) as aforementioned.

In step 4 of FIG. 22, the first UE provides information related to the parameters of signal S (e.g., BFD-RS) to the network (e.g., gNB). In one example, there is no signal transmitted from the first UE to the network (e.g., gNB) to provide parameters related to signal S, for example, the parameters can be determined by pre-configuration or determined by the network (e.g., gNB) as aforementioned. In one example, steps 3 and/or 4 are not performed and the information related to signal S is determined by an earlier configuration.

In one example, after the network (e.g., gNB) receives the signal from the UE1 with the parameters of signal S, the gNB transmits an acknowledgment or feedback. In one example, the acknowledgment or feedback can be a DCI format or MAC CE or ANS.1 message. In one example, if the UE1 does not receive the acknowledgment or feedback, the UE1 (re-)transmits the signal of step 4.

In step 5 of FIG. 22, the UE2 transmits signal S (e.g., BFD-RS). In one example, transmission of signal S can continue until the UE2 receives a message or a signal from the gNB or the first UE or an event to deactivate signal S. In one example, transmission of signal S can be for M occasions. In one example, M is 1. In one example, M can be defined in the system specifications. In one example, M can be configured by RRC signaling and/or MAC CE signaling and/or L1 control signaling. In one example, transmission of signal S can be for M occasions or until a message or an event stops signal S. In one example, the first UE can send a message or signal to the UE2 to stop or deactivate the transmission of signal S. In one example, the gNB can send a message or signal to the UE2 to stop or deactivate the transmission of signal S. In one example, an instance of signal S is associated with a beam.

In step 6 of FIG. 22, the network (e.g., gNB) measures signal S (e.g., BFD-RS). In one example, the network (e.g., gNB) can determine if there is a beam failure based on the measurement of signal S. In one example, the network (e.g., gNB) measures a quality signal S. In one example, the quality measurement is based on a RSRP or RSRQ or SINR of a signal S. In one example, the quality is based on RSSI signal S. In one example, the network (e.g., gNB) is configured with a threshold, wherein if the quality of signal S is less than (or is less than or equal to the threshold), a beam failure detection or beam failure detection instance is declared. In one example, the threshold can be configured and/or updated by higher layer signaling (e.g., SIB-based or using dedicated RRC configuration), or by MAC CE signaling or by L1 control (e.g., DCI) signaling.

In one example, a beam failure detection is declared when a number of beam failure detection instances, K, occurs within a certain time window T. In one example, the K and/or T can be configured and/or updated by higher layer signaling (e.g., SIB-based or using dedicated RRC configuration), or by MAC CE signaling or by L1 control (e.g., DCI) signaling. In one example, beam failure detection is determined by the higher RAN layers (e.g., MAC layer). In one example, beam failure detection is determined by the lower RAN layers (e.g., physical layer). In one example, beam failure instance is determined by the lower RAN layers (e.g., physical layer).

In one example, a beam failure instance is determined based on the second link or BFD-RS and a threshold, as aforementioned, has a degraded quality or has failed. In one example, the network (e.g., gNB) makes the aforementioned determination based on a measurement, e.g., a link quality measurement. In one example, the link quality measurement is based on BLER. In one example, the link quality measurement is based on a RSRP or RSRQ or SINR of a reference signal. In one example, the reference signal can be PUCCH DM-RS for a PUCCH from the UE2 to the network (e.g., gNB). In one example, the reference signal can be PUSCH DM-RS for a PUSCH from the UE2 to the network (e.g., gNB).

In one example, the reference signal can be SRS for an SRS from the UE2) to the network (e.g., gNB). In one example, the reference signal can be a low power reference signal from UE2 to the network (e.g., gNB), e.g., received by a low power receiver. In one example, the reference signal can be PRACH for a PRACH from the UE2 to the network (e.g., gNB). In one example, the reference signal can be BFD-RS from the UE2 to the network (e.g., gNB). In one example, the link quality is based on RSSI of a channel or signal. In one example, the channel or signal is PUCCH or PUCCH-DMRS for a PUCCH from the UE2 to the network (e.g., gNB). In one example, the channel or signal is PUSCH or PUSCH-DMRS for a PUSCH from the UE2 to the network (e.g., gNB). In one example, the channel or signal is SRS for an SRS from the UE2) to the network (e.g., gNB). In one example, the channel or signal is a low power reference signal for UE2 to the network (e.g., gNB), e.g., received by a low power receiver. In one example, the channel or signal is PRACH for a PRACH from the UE2 to the network (e.g., gNB). In one example, the reference signal can be BFD-RS from the UE2 to the network (e.g., gNB).

In one example, the beam failure detection or beam failure detection instance is determined by the network (e.g., gNB).

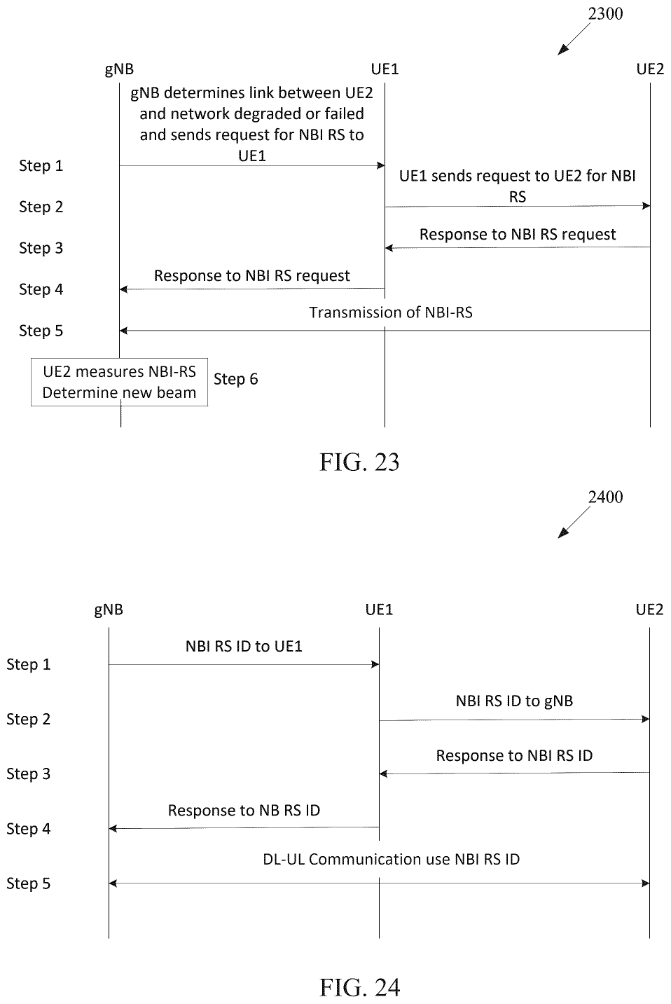

FIG. 23 illustrates yet another signaling flow 2300 of UE assistance of beam failure recovery according to embodiments of the present disclosure. The signaling flow 2300 as may be performed by a UE (e.g., 111-116 as illustrated in FIG. 1). An embodiment of the signaling flow 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions.

The signaling flow of FIG. 23 illustrates an example where a first UE (UE1) can assist a second UE (UE2) with beam failure recovery for a link between the network and the UE2. As illustrated in FIG. 23, the reference signal for beam failure recovery is transmitted by the UE2. In the example illustrated in FIG. 23, the link between the UE2 and the network is to the same gNB as the link between the UE1 and the network, however, the link between the UE1 and the network and the link between the UE2 and the network can use different gNBs or TRPs, a similar procedure is used, but it is understood that internal signaling within the network can be used to establish the link between the network and the UE2 on a gNB different from the gNB used for the UE1. In one example, the recovered link for the UE2 can be to a different gNB than the gNB used for the original link between the network and the UE2.

In the example of FIG. 23, a first link has been established between the gNB and a first UE (e.g., UE1). A second link has been established between the gNB and a second UE. In one example, the gNB of the first link and the gNB of the second link are the same. In one example, the gNB of the first link and the gNB of the second link can be different. In one example, the first link between the first UE and the network can be to more than one gNB as aforementioned. In one example, the second link between the second UE and the network can be to more than one gNB as aforementioned. In one example, the recovered link for the UE2 is to the same gNB as original link between the UE2 and the network. In one example, the recovered link for the UE2 can be to a different gNB than the original link between the UE2 and the network.

In one example, the link between the UE2 and the network (e.g., gNB) can be on the same frequency (e.g., carrier frequency or BWP or CC), a frequency band, or a frequency range as the link between the network and the UE1. In another example, the link between the UE2 and the network (e.g., gNB) can be on a different frequency (e.g., carrier frequency or BWP or CC), or different frequency band or different frequency range than the link between the network and the UE1.

In step 1 of FIG. 23, the network (e.g., gNB) determines beam failure as aforementioned. In one example, the signal in step 1 is transmitted on PDCCH (e.g., DCI Format) or in PDSCH (e.g., MAC CE or DL-SCH or ASN.1 message). In one example, after the UE1 receives the signal from the gNB, the UE1 transmits an acknowledgment or feedback. In one example, the acknowledgment or feedback can be transmitted in a PUCCH or PUSCH. In one example, the acknowledgment or feedback can be a HARQ-ACK. In one example, the acknowledgment or feedback can be a MAC CE or ASN.1 message on PUSCH. In one example, if the gNB does not receive the acknowledgment or feedback, the gNB (re-)transmits the signal of step 1.

In step 2 of FIG. 23, the UE1 sends a request to the UE2 for beam failure recovery on the UE2 link, e.g., the UE2 transmits a reference signal to assist the gNB to perform new beam identification for link with the UE2. In one example, the request from the UE1 to the UE2 provides information about new beam identification reference signal (e.g., NBI-RS) (e.g., resources or resource set(s) or configuration of such signal), wherein the information can be generated by the UE1 or the information can be generated by the gNB. In one example, the request can include positioning information for gNB(s), to assist the UE2 in determining the spatial domain filters (beams) to use to transmit the reference signal (e.g., NBI-RS).

In one example, the information exchange is on SL interface (e.g., PC5 interface), e.g., using NR SL protocol or using LTE SL protocol. In one example, the information exchange is on a non-3GPP interface such as WiFi or Bluetooth. In one example, the UE1 sends a request to the UE2 to assist with beam failure recovery. In one example, the UE1 sends a request to the UE2 to assist with beam failure recovery by requesting transmission of beam failure detection reference signal. In one example, the UE1 provides the UE2 with information about beam failure detection reference signal (e.g., resources or resource set(s) or configuration of such signal).

The UE2 determines a signal S (e.g., NBI-RS) to transmit to assist with new beam identification. In one example, S is a physical random access channel (PRACH). In one example, S is a sounding reference signal (SRS). In one example, S is a PUSCH. In one example, S is a PUSCH DMRS. In one example, S is PUCCH. In one example, S is a PUCCH DMRS. In one example, S is a low power signal received by a low power receiver on the gNB. In one example, signal S can be as illustrated in FIG. 14 (e.g., (a) or (b) as illustrated in FIG. 14).

The parameters of signal S can include at least one of the following examples.

In one example, the parameters of signal S can include time related parameters, including, whether the signal is periodic, semi-persistent or aperiodic with one-shot transmission or N shot transmissions, time of transmission (e.g., symbol and/or slot and/or sub-frame and/or frame). Time of transmission can be an absolute time, or a relative time relative to a second signal or channel (e.g., signal A as discussed later in this disclosure). Time related parameters can also include periodicity of signal S and offset within periodicity. Time related parameters can also include number of transmission instances of signal S for each occasion of signal S. Time related parameters can also include number of transmission occasions of signal S. Time related parameters can also include duration of signal S (e.g., in number of symbols or slots), and time related parameters for each instance of signal S of a transmission occasion of signal S.

In one example, the parameters of signal S can include frequency related parameters, including size in frequency domain (e.g., number of PRBs or number of sub-carriers or number of sub-channels), starting positioning in frequency domain (e.g., starting PRB or starting sub-carrier or starting sub-channel), location of sub-carriers within a PRB, whether a comb-structure is used and the comb size and comb offset, BWP used for signal S, carrier used for signal S. Frequency band of signal S. Frequency region of signal S. Frequency related parameters (including comb if applicable) for each instance of signal S of a transmission occasion of signal S.

In one example, the parameters of signal S can include code related parameters, such as scrambling sequence index, pseudo random sequence index and orthogonal cover index if applicable. Code related parameters for each instance of signal S of a transmission occasion of signal S if applicable.

In one example, the parameters for signal S (e.g., NBI-RS) are determined by the second UE as aforementioned. In one example, the parameters for signal S (e.g., NBI-RS) are determined by the first UE as aforementioned. In one example, the parameters for signal S (e.g., NBI-RS) are determined by the network (e.g., gNB). In one example, the parameters for signal S (e.g., NBI-RS) are determined by the second UE and/or the first UE and/or the network (e.g., gNB).

Signal A can be one of the following: (i) signal transmitted from the UE1 to the UE2 in step 2 of FIG. 23 for a new beam identification for the UE2; (ii) acknowledgment or feedback to signal transmitted from the UE1 to the UE2 in step 2 of FIG. 23 for new beam identification for the UE2; signal transmitted in step 3 of FIG. 23 with information about signal S; and/or (iv) acknowledgement or feedback to signal transmitted in step 3 of FIG. 23 with information about signal S.

In one example, signal S is as aforementioned in FIG. 17.

In one example, a UE2 transmits an NBI-RS continuously (e.g., periodically with periodic occasions), wherein the reference signal is as aforementioned. In one example, a UE2 transmits NBI-RS on demand.

In step 3 of FIG. 23, the UE2 provides information related to the parameters of signal S (e.g., NBI-RS), as aforementioned, to the UE1. In one example, the UE1 provides information on signal S to the UE2 on a wireless interface between the UE1 and the UE2. In one example, the wireless interface is a SL interface (e.g., PC5 interface), e.g., using NR SL protocol or using LTE SL protocol. In one example, the wireless interface is a non-3GPP interface such as WiFi or Bluetooth. In one example, there is no signal transmitted from the UE2 to provide parameters related to signal S, for example, the parameters can be determined by pre-configuration or determined by the first UE or the network (e.g., gNB) as aforementioned.

In step 4 of FIG. 23, the UE1 provides information related to the parameters of signal S (e.g., NBI-RS) to the network (e.g., gNB). In one example, there is no signal transmitted from the UE1 to the network (e.g., gNB) to provide parameters related to signal S, for example, the parameters can be determined by pre-configuration or determined by the network (e.g., gNB) as aforementioned. In one example, steps 3 and/or 4 are not performed and the information related to signal S is determined by an earlier configuration. In one example, after the network (e.g., gNB) receives the signal from the UE1 with the parameters of signal S, the gNB transmits an acknowledgment or feedback. In one example, the acknowledgment or feedback can be a DCI format or MAC CE or ANS.1 message. In one example, if the UE1 does not receive the acknowledgment or feedback, the UE1 (re-)transmits the signal of step 4.

In step 5 of FIG. 23, the UE2 transmits signal S (e.g., NBI-RS). In one example, transmission of signal S can continue until the UE2 receives a message or a signal from the gNB or the first UE or an event to deactivate signal S. In one example, transmission of signal S can be for M occasions. In one example, M is 1. In one example, M can be defined in the system specifications. In one example, M can be configured by RRC signaling and/or MAC CE signaling and/or L1 control signaling. In one example, transmission of signal S can be for M occasions or until a message or an event stops signal S. In one example, the first UE can send a message or signal to the UE2 to stop or deactivate the transmission of signal S. In one example, the gNB can send a message or signal to the UE2 to stop or deactivate the transmission of signal S. In one example, an instance of signal S is associated with a beam.

In step 6 of FIG. 23, the network (e.g., gNB) measures signal S (e.g., NBI-RS). In one example, based on the measurement of signal S, the network (e.g., gNB) identifies a new beam for communication with the UE2. In one example each occasion of signal S includes N instances as aforementioned. In one example, the network (e.g., gNB) identifies an instance of signal S based on the signal quality of the instance of S (e.g., quality can be RSRP or RSSI or RSRQ or SINR) for the corresponding instance. e.g., instance of signal S with a quality above a threshold or an instance of signal S with the best (e.g., highest) quality. In one example, an instance of signal S is associated with a beam. In one example, the new beam identified is associated with the same gNB that the UE2 used to communicate with the network. In one example, the new beam identified can be associated with a different gNB than that the UE2 used to communicate with the network. In one example, the new beam identified is associated with the same gNB that the UE1 uses to communicate with the network. In one example, the new beam identified can be associated with a different gNB than that the UE1 uses to communicate with the network.

In one example, the new beam is identified based on an instance of signal S (e.g., NBI-RS) determined as aforementioned. In one example, a new beam is associated with an instance (e.g., ID) of signal S. In one example, a network (e.g., gNB) indicates an instance (e.g., ID) of signal S for the new beam.

In one example, a network (e.g., gNB) indicates the new beam to the UE2. In one example, a network (e.g., gNB) indicates the new beam directly to the UE2 as explained later in this disclosure. In one example, a network (e.g., gNB) indicates the new beam to the UE2 through the UE1 as explained later in this disclosure.

In one example, a network (e.g., gNB) uses DL channel or signal to the UE2 to indicate the newly identified beam (e.g., instance of (e.g., ID) of signal S). In one example, the DL channel is PDSCH. In one example, the DL channel is PDCCH. In one example, the DL signal is SSB. In one example, the DL signal is channel state information reference signal (CSI-RS). In one example, the DL channel or signal is a wake-up signal (WUS). In one example, the DL channel or signal is a channel or signal received by a low power receiver.

In one example, the resources for the DL transmission conveying the beam indication is determined by the UE2. In one example, the resources for the DL transmission conveying the beam indication is determined by the UE2 and conveyed to the network (e.g., UE2) via step 3 and step 4 of FIG. 23. In one example, the resources for the DL transmission conveying the beam indication is determined by the UE1. In one example, the resources for the DL transmission conveying the beam indication is determined by the UE1 and conveyed to the UE2 via step 2 of FIG. 23. In one example, the resources for the DL transmission conveying the beam indication is determined by the UE1 and conveyed to the network (e.g., gNB) via step 4 of FIG. 23. In one example, the resources for the DL transmission conveying the beam indication is determined by the network (e.g., gNB). In one example, the resources for the UL transmission conveying the beam indication is determined by the network (e.g., gNB) and conveyed to the UE2 via step 1 and step 2 of FIG. 23, or by system information.

In one example, after the UE receives a new beam indication from the network (e.g., gNB), the UE2 responds with a UL channel or signal confirming the reception of the new beam indication. In one example, the UL channel is PUSCH. In one example, the UL channel is PUCCH. In one example, the UL channel is PRACH. In one example, the UL channel is PRACH using a contention free random access (CFRA) or dedicated preamble. In one example, the UL channel is PRACH using a contention based random access (CBRA) or common preamble. In one example, the UL signal is sounding reference signal (SRS). In one example, the UL channel or signal is a wake-up signal (WUS). In one example, the UL channel or signal is a channel or signal received by a low power receiver. In one example, the UL transmission with the new beam indication is UE-initiated (e.g., initiated by the UE2).

In one example, the resources for the UL transmission is determined by the UE2. In one example, the resources for the UL transmission is determined by the UE2 and conveyed to the network (e.g., gNB) via step 3 and step 4 of FIG. 23. In one example, the resources for the UL transmission is determined by the UE1. In one example, the resources for the UL transmission is determined by the UE1 and conveyed to the UE2 via step 2 of FIG. 23. In one example, the resources for the UL transmission is determined by the UE1 and conveyed to the network (e.g., gNB) via step 4 of FIG. 23. In one example, the resources for the UL transmission is determined by the network (e.g., gNB). In one example, the resources for the UL transmission is determined by the network (e.g., gNB) and conveyed to the UE2 via step 1 and step 2 of FIG. 23 or by system information. In one example, the resources for the UL transmission is determined based on the resources for DL transmission conveying the beam indication, for example based on a configured mapping between the DL and UL resources used for the DL and UL transmissions.

In one example, a UL transmission is transmitted using the new beam identified. In one example, the new beam for communication between the UE2 and the network (e.g., gNB) is activated starting from a time T from UL or DL transmission (start or end of UL or DL transmission). In one example T is specified in the system specification and/or configured or updated SIB signaling and/or RRC signaling and/or MAC CE signaling and/or L1 control (e.g., DCI) signaling.

In one example, after the UE2 receives a new beam indication from the network (e.g., gNB), the UE2 responds with a UL channel or signal confirming the reception of the new beam indication via the UE1.

FIG. 24 illustrates yet another signaling flow 2400 of UE assistance of beam failure recovery according to embodiments of the present disclosure. The signaling flow 2400 as may be performed by a UE (e.g., 111-116 as illustrated in FIG. 1). An embodiment of the signaling flow 2400 shown in FIG. 24 is for illustration only. One or more of the components illustrated in FIG. 24 can be implemented in a specialized circuitry configured to perform the noted functions or one or more of the components can be implemented by one or more processors executing instructions to perform the noted functions.

The signaling flow of FIG. 24 illustrates an example where a first UE (UE1) can assist second UE (UE2) with beam failure recovery for a link between the network and the UE2. In the example illustrated in FIG. 24, the link between the UE2 and the network is to the same gNB as the link between the UE1 and the network, however, the link between the UE1 and the network and the link between the UE2 and the network can use different gNBs or TRPs, a similar procedure is used, but it is understood that internal signaling within the network can be used to establish the link between the network and the UE2 on a gNB different from the gNB used for the UE1.

In one example of FIG. 24, a first link has been established between the gNB and a first UE (e.g., UE1). A second link has been established between the gNB and a second UE. In one example, the gNB of the first link and the gNB of the second link are the same. In one example, the gNB of the first link and the gNB of the second link can be different. In one example, the first link between the first UE and the network can be to more than one gNB as aforementioned. In one example, the second link between the second UE and the network can be to more than one gNB as aforementioned.

In one example, the link between the UE2 and the network (e.g., gNB) can be on the same frequency (e.g., carrier frequency or BWP or CC) or frequency band or frequency range as the link between the network and the UE1. In another example, the link between the UE2 and the network (e.g., gNB) can be on a different frequency (e.g., carrier frequency or BWP or CC), or different frequency band or different frequency range than the link between the network and the UE1.

In step 1 of FIG. 24, the network (e.g., gNB) determines a new beam (e.g., instance of signal S discussed in conjunction with FIG. 23), as aforementioned. The network (e.g., gNB) conveys the new beam to the network via the UE1. In step 1 of FIG. 24, the network (e.g., gNB) sends the new beam indication to the UE1. In one example, the information is transmitted on a DL channel or signal. In one example, after the UE1 receives the signal from the gNB, the UE1 transmits an acknowledgment or feedback. In one example, the acknowledgment or feedback can be on PUCCH or PUSCH. In one example, the acknowledgment can be a HARQ-ACK. In one example, the acknowledgment or feedback can be a MAC CE or ASN.1 message on PUSCH. In one example, if the gNB does not receive the acknowledgment or feedback, the gNB (re-)transmits the information to the UE1. In one example, the network (e.g., gNB) sends a new beam indication (e.g., instance of signal S discussed in conjunction with FIG. 23) to the UE1.

In step 2 of FIG. 24, the UE1 sends the new beam indication to the UE2. In one example, the UE1 transmits the beam indication on a SL interface (e.g., PC5 interface), e.g., using NR SL protocol or using LTE SL protocol. In one example, the information is transmitted on a non-3GPP interface such as WiFi or Bluetooth.

In step 3 of FIG. 24, the UE2 provides a response to the signal transmitted in step 2. In one example, signal in step 3 can include a time when the new beam becomes active. In one example, the time is a relative time (for example relative to the signal transmitted in step 2 or step 3). In one example, the time is an absolute time. In one example, after the UE1 receives the signal from the UE2, the UE1 transmits an acknowledgment or feedback. In one example, if the UE2 does not receive the acknowledgment or feedback, the UE2 (re-)transmits the signal. The UE2 provides information to the UE1 on a wireless interface between the UE1 and the UE2. In one example, the wireless interface is a SL interface (e.g., PC5 interface), e.g., using NR SL protocol or using LTE SL protocol. In one example, the wireless interface is a non-3GPP interface such as WiFi or Bluetooth. In one example, there is no signal transmitted from the gNB the new beam comes active at a pre-determined time.

In step 4 of FIG. 24, the UE1 provides a response back to the network (e.g., gNB). In one example, signal in step 4 can include a time when the new beam becomes active. In one example, the time is a relative time (for example relative to the signal transmitted in step 4). In one example, the time is an absolute time. In one example, steps 3 and/or 4 are not performed, the new beam comes active at a pre-determined time. In one example, after the gNB receives the signal from the UE1, the gNB transmits an acknowledgment or feedback. In one example, the acknowledgment or feedback can be transmitted in a DCI format or MAC CE or ASN.1 message. In one example, if the UE1 does not receive the acknowledgment or feedback, the UE1 (re-)transmits the signal.

In step 5 of FIG. 24, at a time determined by pre-configuration or conveyed in the signal in step 2 or step 3 or step 4, the UE2 and the network (e.g., gNB) communicate on the new beam.

The present disclosure provides: (i) a first UE can assist with beam failure recovery of a second UE; (ii) a triggering transmission of reference signals for beam management for beam failure recovery with assistance from first UE; (iii) reference signals for beam failure recovery transmitted by the network or by second UE; and (iv) procedure to identify and signal a new beam pair between the gNB and second UE based on assistance provided by first UE.

Beam management is in an essential component of wireless cellular systems operating in FR2. Having a low overhead, low latency, low power and low complexity beam management algorithm is an important design criterion. Furthermore, by having common beam management components that can be used in different scenarios (e.g., initial beam pairing, beam maintenance and beam recovery) complexity is reduced. To this end, the method provides a mechanism to trigger beam management reference signals on demand, and provide relevant assistance by another UE, hence making the beam management procedure more efficient and with reduced latency.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A first user equipment (UE), comprising:
a processor configured to detect a beam failure; and
a transceiver operably coupled to the processor, the transceiver configured to:
transmit, to a second UE, a first beam failure detection message, and
receive, from the second UE, a first configuration related to first reference signals (RSs) for beam recovery,
wherein the processor is further configured to determine a first RS from the first RSs to use for beam recovery.

2. The first UE of claim 1, wherein the transceiver is further configured to transmit, to a base station, a message indicating the first RS.

3. The first UE of claim 1, wherein the transceiver is further configured to transmit, to the second UE, a message indicating the first RS.

4. The first UE of claim 1, wherein the transceiver is further configured to:
receive, from a third UE, a second beam failure detection message,
transmit, to a base station (BS), the second beam failure detection message,
receive, from the BS, a second configuration related to second RSs for beam recovery, and
transmit, to the third UE, the second configuration.

5. The first UE of claim 1, wherein the transceiver is further configured to:
receive, from a third UE, a first signal indicating an identity of a RS for beam recovery, and
transmit, to a base station, a second signal indicating the identity of the RS for beam recovery.

6. The first UE of claim 1, wherein:
the processor is further configured to determine an intent to establish a communication channel with a base station (BS),
the transceiver is further configured to:
transmit, to the second UE, a channel setup request, and
receive, from the second UE, a second configuration related to a second set of RSs for channel setup,
the processor is further configured to identify a second RS from the second set of RSs to use for subsequent communication with the BS, and
the transceiver is further configured to transmit, to the BS, a signal indicating the second RS.

7. The first UE of claim 1, wherein the transceiver is further configured to:
receive, from a third UE, a channel setup request for the third UE,
transmit, to a base station (BS), the channel setup request for the third UE,
receive, from the BS, a second configuration of second RSs for channel setup, and
transmit, to the third UE, the second configuration of second RSs for channel setup.

8. The first UE of claim 1, wherein:
the transceiver is further configured to receive, from a third UE, a request to setup a channel, and
determination that the first UE wants to setup the channel is based on the request.

9. A base station (BS), comprising:
a transceiver configured to receive a first message, from a first user equipment (UE), indicating beam failure detection at a second UE; and
a processor operably coupled to the transceiver, the processor configured to determine, based on the first message, a configuration related to first reference signals (RSs) for beam recovery at the second UE,
wherein the transceiver is further configured to transmit, to the first UE, a second message that includes the configuration related to first RS.

10. The BS of claim 9, wherein the transceiver is further configured to receive, from the first UE, a signal indicating an identity of a RS in the first RSs for beam recovery at the second UE.

11. The BS of claim 9, wherein the transceiver is further configured to receive, from the second UE, a signal indicating an identity of a RS in the first RSs for beam recovery at the second UE.

12. The BS of claim 9, wherein:
the transceiver is further configured to receive, from the first UE, a third message containing a channel setup request for the second UE,
the processor is further configured to determine, based on the third message, a second configuration related second reference signals (RSs) for channel setup at the second UE, and
the transceiver is further configured to transmit, to the first UE, the second configuration of second RSs for channel setup.

13. A method of operating a first user equipment (UE), the method comprising:
detecting a beam failure;
transmitting, to a second UE, a first beam failure detection message;
receiving, from the second UE, a first configuration related to first reference signals (RSs) for beam recovery; and
determining a first RS from the first RSs to use for beam recovery.

14. The method of claim 13, further comprising transmitting, to a base station, a message indicating the first RS.

15. The method of claim 13, further comprising transmitting, to the second UE, a message indicating the first RS.

16. The method of claim 13, further comprising:
receiving, from a third UE, a second beam failure detection message;
transmitting, to a base station (BS), the second beam failure detection message;
receiving, from the BS, a second configuration related to second RSs for beam recovery; and
transmitting, to the third UE, the second configuration.

17. The method of claim 13, further comprising:
receiving, from a third UE, a first signal indicating an identity of a RS for beam recovery; and
transmitting, to a base station, a second signal indicating the identity of the RS for beam recovery.

18. The method of claim 13, further comprising:
determining an intent to establish a communication channel with a base station (BS);
transmitting, to the second UE, a channel setup request;
receiving, from the second UE, a second configuration related to a second set of RSs for channel setup;
identifying a second RS from the second set of RSs to use for subsequent communication with the BS; and
transmitting, to the BS, a signal indicating the second RS.

19. The method of claim 13, further comprising:
receiving, from a third UE, a channel setup request for the third UE;
transmitting, to a base station (BS), the channel setup request for the third UE;
receiving, from the BS, a second configuration of second RSs for channel setup; and
transmitting, to the third UE, the second configuration of second RSs for channel setup.

20. The method of claim 13, further comprising:
receiving, from a third UE, a request to setup a channel; and
determining that the first UE wants to setup the channel based on the request.
